(19) United States
(12) Patent Application Publication
(10) Pub. No.: US 2024/0318102 A1
(43) Pub. Date: Sep. 26, 2024

(54) IMPROVED ENZYME-CONTAINING ADDITIVE AND DETERGENT LIQUOR FORMULATIONS

(71) Applicant: CHRISTEYNS, Gent (BE)

(72) Inventors: Simon LAMBERT, Gent (BE); Brian DEMUYNCK, Gent (BE); Olivier MAREAU, Gent (BE); Christian VERMOTE, Gent (BE); Franck DE MEULEMEESTER, Gent (BE)

(21) Appl. No.: 18/574,498

(22) PCT Filed: Jun. 29, 2022
(86) PCT No.: PCT/EP2022/067981

§ 371 Date: Dec. 27, 2023

(30) Foreign Application Priority Data
Jun. 29, 2021 (EP) 21182308.3

(51) Int. Cl. C11D 3/386; C11D 1/75; C11D 11/00

(52) U.S. Cl. CPC C11D 3/38618; C11D 1/75; C11D 3/38627; C11D 11/0094

(57) ABSTRACT

Disclosed is an additive and an aqueous liquor for washing or cleaning comprising at least one lipase enzyme concentrate in a specified range plus at least one protease enzyme concentrate, also containing total proteins in a specified range, further containing at least one amine oxide as a first surfactant and optionally containing further selected surfactants. Further disclosed is a process for producing these products, some including the use of a highly suitable apparatus that may also be equipped for supplying the additive to an on-site washing and/or cleaning operation. Further disclosed is the use of the products in the context of performing a washing or cleaning step.

### FIELD OF THE INVENTION

The present invention relates to the field of washing and cleaning and is directed to an improvement of a washing or cleaning agent that contains an enzyme. More particularly, the invention relates to a washing and cleaning agent that is based on an enzyme concentrate that is containing a lipase enzyme and a protease enzyme.

### BACKGROUND OF THE INVENTION

The use of enzymes in washing and cleaning agents is established in the existing art. They serve to expand the performance spectrum of the relevant agents in accordance with their specific activities.

Enzymes are three-dimensional structures of proteins that exhibit activity as biocatalysts, i.e. substances of a biochemical nature that accelerate chemical reactions. The enzymes are thus not consumed in the chemical reaction. Enzymes in general are limited in the number of reactions they have evolved to catalyse. The molecules upon which enzymes may act are called substrates, and the enzyme converts the substrates into different molecules known as products.

Enzymes are typically very specific in the type of substrate they are active upon, and are often named after that type of substrate. A protease is an enzyme that is able to breakdown proteins into smaller polypeptides and/or single amino acids. Many commercial forms of protease exist in the form of enzyme concentrates, such as Savinase®, Liquanase®, Coronase® (from Novozymes), Optimase®, Preferenz® (from DuPont), and Lavergy® (from BASF). Lipase catalyses the breakdown of triglycerides, also called “lipids”. α-Amylase catalyses the hydrolysis of starch into di- and trisaccharides. Other forms of amylase, also called mannase or mannanase, catalyse the breakdown of oligosaccharides into sugars. Pectinase, e.g. pectin lyase or pectolyase, degrades residual fruit starch, known as pectin. Cellulases are able to degrade cellulose, including cell walls. These enzymes, including lipase, are commonly used in laundry and dishwashing detergents.

Most commonly used are hydrolytic enzymes such as proteases, amylases, lipases, and cellulases. The first three of these enzymes hydrolyse proteins, starch, and fats, respectively, and thus contribute directly to stain removal. Cellulases are used in particular because of their fabric effect. A further group of washing- and cleaning-agent enzymes includes the oxidative enzymes, in particular oxidases that either alone or in interaction with other components serve to bleach surface stains or generate bleaching agents in situ. In addition to these enzymes, which are the subject of continuing optimization, other enzymes are constantly being made available for use in washing and cleaning agents to address specific stains. These additional enzymes include pectinases, β-glucanases, mannanases, or additional hemicellulases for the hydrolysis of specific plant polymers.

U.S. Pat. No. 7,608,573 B1 discloses a number of heavy duty cleaning compositions containing a variety of surfactant cocktails, all containing as the key component for lowering the interfacial tension (IFT) a C6-C8 alkyl polyglucoside, several of the cocktails comprising an amine oxide as a non-ionic surfactant, often together with another longer chain alkyl polyglucoside. Samples A to F further contain a protease concentrate, A and B comprise in addition an amylase concentrate. Lipase is listed as a suitable enzyme but was not exemplified.

Lipase enzymes are of high interest in a washing process because they catalyse the hydrolysis of fats (lipids), typically by hydrolysing two of the ester bonds and converting the triglyceride to a monoglyceride plus two fatty acids.

The lipase enzymes however have a particularly strong compatibility and/or interference problem with many of the surfactants that may be used in detergent formulations. They are much more sensitive than the other enzymes of common use in laundry and dishwashing.

The inventors have found that many surfactants have a strong suppressing effect on the catalytic activity of a lipase enzyme on the hydrolysis of lipids. This was demonstrated by the inventors on rapeseed oil for linear alkyl benzene sulphonate (LABS), an anionic surfactant, and for ethoxylates having 3, 5, 7, 9 and 10 EO monomers as part of isoC13-type ethoxylates and having 3, 5 and 7 EO monomers on a linear C13/15 ethoxylate, non-ionic surfactants, at 100 ppm concentration in the washing liquor.

The inventors have further found that the combination of lipase enzymes with other enzymes, e.g. with protease, and/or with many surfactants in an aqueous environment rather quickly leads to the formation of a deposit, in particular when used in a concentrate that is intended for being be added to the washing liquor. The formulation is therefore usually not stable.

Protease is an enzyme that catalyses the breakdown of proteins, and enzymes are protein structures. Therefore, in a combination of a protease enzyme with other enzymes into the same composition, the protease may thus possibly affect other enzymes. WO 2017/211698 A1 describes that protease and lipase cannot usually be combined in a single liquid composition because the protease may digest the lipase on storage, and that, similarly, protease may digest cellulase on storage in a liquid. The document proposes, in order to access the assorted benefits of these enzymes in a single load, to use more than one reservoir comprising an enzyme composition.

There therefore remains a need for improvements in the formulation of washing and cleaning agents containing enzymes, in particular containing several different enzymes, and especially those containing a protease enzyme.

WO 2017/027944 A1 and MX 2018001840 A are concerned with enzymatic stability and the performance of enzymes for washing fabrics and surfaces, and propose to combine at least one enzyme with at least one anionic, amphoteric and non-ionic surfactant, whereby the anionic surfactant is sodium lauryl ether sulphate (SLES) and/or linear alkylbenzene sulphonate (LAS or LABS) and wherein the amphoteric surfactant is amine oxide (AO) and/or cocamidopropyl betaine (CAPB). In Example 1, the enzyme activity at 30° C. and 37° C. was tested, at weeks 0, 4 and 8, individually of protease, amylase, mannanase, lipase and pectin lyase in the presence of one of the surfactants SLES, CAPB, LAS/7EO 30/70%, AO/10EO 30/70% and SLES/7EO 30/70%. Almost all enzymes showed a drop in activity over the test, with the exception of amylase combined with the SLES at both temperatures or with the LAS/7EO mixture at 30° C. showing a modest increase. In Example 2, two mixtures of surfactants (SLES/AO 90/10% and SLES/CAPB/AO 80/10/10%) were tested together with (an) unidentified enzyme(s) on a variety of cleaning stains most common to consumers, and these formulations outperformed the not further defined comparative surfactant mixtures LAS/Alkyl ether sulphate (AES)/polyoxylated alkyl and LAS/AES/polyalkyl ethoxylate. The concentrations of the individual ingredients in the tested compositions can however not be derived from the publication.

US 2011/0201536 A1 is concerned with improving the cleaning performance of a washing or cleaning agent containing a hydrolytic enzyme, and proposes to add to the agent a component capable of producing a synergistic cleaning performance interaction with the hydrolytic enzyme selected from (i) an amino acid or polyamino acid, or derivatives thereof; (ii) a biosurfactant; or (iii) a microbial metabolite, or mixtures thereof, or (iv) a preparation of a microbial culture supernatant that contains at least 2.5 wt % of one of the substances (i), (ii) or (iii). The test formulations used in the examples were textile washing agents combined with only protease as the enzyme.

There therefore remains a need for improvements in the formulation of washing and cleaning agents containing at least one lipase enzyme and at least one protease enzyme.

The present invention aims to obviate or at least mitigate the above described problem and/or to provide improvements generally.

### SUMMARY OF THE INVENTION

According to the invention, there is provided an additive, a liquor, uses thereof and processes for their production and employment, as defined in any of the accompanying claims.

In an embodiment, the invention provides an enzyme-containing additive for washing or cleaning comprising at least one protease enzyme concentrate and at least one lipase enzyme concentrate, characterised in that
the additive comprises the at least one lipase enzyme concentrate in a concentration of at least 0.2% wt, preferably at least 5% wt, and optionally at most 50% wt of the at least one lipase enzyme concentrate, taking into account the total enzyme concentrate in its liquid form (wet basis),
the additive comprises at least 0.7% wt of total proteins, preferably at least 4% wt and optionally at most 10% wt of total proteins,
the additive further comprises at least one amine oxide as a first surfactant, preferably at a concentration in the range of at least 1% wt, optionally at most 15% wt, and typically about 3% wt, and
the additive optionally further comprises at least one non-ionic surfactant as a second surfactant, preferably the second surfactant being an alkoxylated surfactant or an alkyl polyglycoside, more preferably an alkyl polyglycoside, preferably at a concentration of at most 5% wt,
the additive optionally further comprises a total of surfactants other than amine oxide and non-ionic surfactant in a concentration of at most 200% of the concentration of the at least one amine oxide.

In an embodiment, the invention provides an enzyme-containing additive in liquid form for washing or cleaning comprising at least one protease enzyme concentrate and at least one lipase enzyme concentrate, wherein
the additive comprises the at least one lipase enzyme concentrate in a concentration of at least 0.2% wt, preferably at least 5% wt, and optionally at most 50% wt of the at least one lipase enzyme concentrate, taking into account the total enzyme concentrate in its liquid form (wet basis),
the additive comprises at least 0.7% wt of total proteins, preferably at least 4% wt and optionally at most 10% wt of total proteins,
the additive further comprises at least one amine oxide as a surfactant, preferably at a concentration in the range of at least 1% wt, optionally at most 15% wt, and typically about 3% wt, characterized in that
the additive comprises no surfactant other than the at least one amine oxide, except for surfactants that may have been present as a component in the non-surfactant ingredients used for preparing the additive.

The enzyme-containing additive may in this document also be called an additive formulation and may also be called a detergent formulation.

In an embodiment, the invention further provides an aqueous liquor for washing or cleaning that is comprising the additive according to the present invention.

In an embodiment of the liquor according to the present invention, the liquor complies with at least one and preferably with all of the following conditions:
the liquor comprises the at least one lipase enzyme concentrate at a concentration of at least 5 ppm and at most 500 ppm by weight, taking into account the total enzyme concentrate in its liquid form (wet basis),
the liquor comprises the at least one protease enzyme concentrate at a concentration of at least 5 ppm and at most 500 ppm by weight, taking into account the total enzyme concentrate in its liquid form (wet basis),
the liquor comprises total proteins at a concentration of at least 10 ppm by weight and at most 600 ppm by weight, typically about 50-60 ppm by weight,
the liquor further comprises at least one amine oxide as a first surfactant in a concentration of at least 1 ppm by weight and at most 100 ppm by weight, typical about 10-15 ppm by weight,
the liquor optionally further comprises at least one non-ionic surfactant as a second surfactant, preferably an alkoxylated surfactant or an alkyl polyglycoside, more preferably an alkyl polyglycoside, preferably at a concentration of at most 400 ppm by weight, and
the liquor optionally further comprises a total of surfactants other than the amine oxide and the at least one non-ionic surfactant in a concentration of at most 200% of the concentration of the amine oxide, wherein the liquor preferably comprises no surfactant other than the amine oxide, except for surfactants that may have been present as a component in the non-surfactant ingredients used for preparing the liquor.

In an embodiment, the present invention provides for a process for producing the additive according to the present invention, the process comprising the step of adding the at least one lipase enzyme concentrate, the at least one protease concentrate and the at least one amine oxide together, optionally also with a suitable liquid, preferably this liquid being water, and mixing the added ingredients and components to form the additive.

In an embodiment of the present invention, the process further comprises the step of producing the liquor according to the present invention, preferably comprising the step of adding water to the additive.

In an embodiment, the present invention provides for the use of the additive according to the present invention for preparing an aqueous liquor for washing or cleaning, preferably a liquor for a prewash step.

In an embodiment, the present invention provides for the use of the liquor according to the present invention for performing a washing or cleaning step, preferably for performing a prewash step.

We have surprisingly found that the presence of the at least one amine oxide as the first surfactant improves the stability of the at least one lipase enzyme in the concentrated additive formulation, especially in view of the presence of also at least one protease enzyme, avoiding phase separation and also enhances in the washing liquor made from the additive the catalytic activity of the lipase enzyme towards the hydrolysis of lipids when used in a washing step relative to the same formulation without the amine oxide.

The inventors have even more surprisingly found that the at least one amine oxide is capable of increasing the activity of the lipase activity, up to 280%, relative to the activity that the enzyme exhibits in absence of the amine oxide. Rather than the lipase activity being suppressed by the surfactant, its activity may now be increased significantly thanks to the presence of the amine oxide.

The applicants have further found that the effect of the present invention remains obtainable if in addition to the amine oxide also an extra surfactant is present in the additive and/or in the washing liquor. The applicants have found that a non-ionic surfactant, such as ethoxylated isoC13 alcohol carrying on average 5 ethylene oxide (EO) monomers and/or ethoxylated linear C12-C15 alcohol having an average degree of ethoxylation of at least 5, is highly suitable. The applicants have found that the concentration of the non-ionic surfactant may be as high as 400 ppm by weight in the washing liquor, which may be desired for cleaning heavily soiled textile. Preferably the concentration of the non-ionic surfactant is however less than 400 ppm, because the extra surfactant competes with the amine oxide and with the enzyme(s) for approaching soil and stains and may thus reduce the beneficial effects that are brought by the amine oxide and/or of the enzyme(s). The applicants have surprisingly found that the alkyl polyglycoside hardly changes the beneficial effect of the present invention, and therefore is a non-ionic surfactant that is preferred as an extra surfactant in the compositions according to the present invention in addition to the at least one amine oxide.

### BRIEF DESCRIPTION OF THE DRAWINGS

FIG. 1 shows the results of the activity of washing liquors containing all the same concentration of the same lipase enzyme concentrate for the total hydrolysis of rapeseed oil in the absence and in the presence of one particular surfactant that was selected from a wide range of different surfactants.

FIG. 2 is a schematic view of an embodiment of the present invention showing a supply system wherein an on-site apparatus is provided for preparing at least one and preferably a plurality of additives according to the present invention and capable of supplying the prepared additives via hardware connections to a set of on-site treatment devices.

FIG. 3 shows a schematic view of how the apparatus of FIG. 2 may be connected electronically and preferably virtually with a server and how information may flow back and forth between the apparatus and the server.

### DETAILED DESCRIPTION

The following detailed description does not limit the invention. Instead, the scope of the invention is defined by the appended claims.

Several documents are cited throughout the text of this specification. Each of the documents herein (including any manufacturer's specifications, instructions etc.) are hereby incorporated by reference; however, there is no admission that any document cited is indeed prior art to the present invention.

The detailed description serves the purpose of describing preferred embodiments of the present invention and is not intended for being a limited representation of the only embodiments in which the present invention may occur or may be applied. The description attempts the clarify the functionalities and the steps that are required for creating the invention and to reduce it to practice. It should be understood that the same or equivalent functionalities and parts may be obtained in or with other embodiments and that also those are intended to be comprised in the scope of the present invention.

The present invention will hereinafter be described in particular embodiments, and with possible reference to particular drawings. The invention is however not limited thereto, it is only limited by the claims. Any drawings described are only schematic and are non-limiting. In the drawings, the size of some of the elements may be exaggerated and not drawn to scale for illustrative purposes. The dimensions and the relative dimensions in the drawings do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than those described and/or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein may operate in other orientations than described or illustrated herein.

The verb “to comprise”, as used in the claims in its various grammatical forms, should not be considered as being limited to the elements that are listed in context with it. It does not exclude that there are other elements or steps. It should be considered as the presence provided of these features, integers, steps or components as required, but does not preclude the presence or addition of one or more other features, integers, steps or components, or groups thereof. Thus, the volume of “an article comprising means A and B” may not be limited to an object which is composed solely of agents A and B. It means that A and B are the only elements of interest to the subject matter in connection with the present invention. In accordance with this, the terms “comprise” or “embed” enclose also the more restrictive terms “consisting essentially of” and “consist of”. By replacing “comprise” or “include” with “consist of” these terms therefore represent the basis of preferred but narrowed embodiments, which are also provided as part of the content of this document with regard to the present invention.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding the understanding of one or more of the various inventive aspects. This method of disclosure, however, is not to be interpreted as reflecting an intention that the claimed invention requires more features than are expressly recited in each claim. Rather, as the claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the claims, any one of the claimed embodiments can and may be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Other embodiments of the invention will be apparent to those skilled in the art from consideration of the specification and practice of the invention disclosed herein. It is intended that the specification and examples be considered as exemplary only. Each and every claim is incorporated into the specification as an embodiment of the present invention. Thus, the claims are part of the description and are a further description and are in addition to the preferred embodiments of the present invention. Every one of the claims sets out at least one particular embodiment of the invention. The following terms are provided solely to aid in the understanding of the invention.

Unless specified otherwise, all ranges provided herein include up to and including the endpoints given, and the values of the constituents or components of the compositions are expressed in weight percent or % by weight of each ingredient in the composition.

As used herein, “weight percent,” “wt-%”, “wt %”, “percent by weight”, “% by weight”, “ppmwt”, “ppm by weight”, “weight ppm” or “ppm” and variations thereof refer to the concentration of a substance as the weight of that substance divided by the total weight of the composition and multiplied by 100 or 1,000,000 as appropriate, unless specified differently. It is understood that, as used here, “percent”, “%”, are intended to be synonymous with “weight percent”, “wt-%”, etc., unless otherwise specified.

It should be noted that, as used in this specification and the appended claims, the singular forms “a,” “an,” and “the” include plural referents unless the content clearly dictates otherwise. Thus, for example, reference to a composition containing “a compound” includes a composition having two or more compounds. It should also be noted that the term “or” is generally employed in its sense including “and/or” unless the content clearly dictates otherwise.

Additionally, each compound used herein may be discussed interchangeably with respect to its chemical formula, chemical name, abbreviation, etc. . . .

In the context of the present invention, with a liquor for washing or cleaning is meant a composition for use as the agent in a washing or cleaning bath. A “washing or cleaning bath” is understood as that functional solution containing the agent for washing or cleaning that acts on textiles or fabric (washing bath) or hard surfaces (cleaning bath), and which comes in contact with the stains present on textiles or fabrics, or on hard surfaces. The washing or cleaning bath is usually created when the washing or cleaning operation begins and the washing or cleaning agent is dissolved in or diluted with water, for example in a washing machine or in another suitable vessel.

The liquor for washing or cleaning is thus typically an aqueous composition, meaning that it has water as the continuous phase. The usual characteristic of aqueous compositions is that the water is used as the carrier for most of the other ingredients of the composition. In the context of a liquor for washing or cleaning the water typically also serves as a carrier for the products of the washing or cleaning step, i.e. products that are formed by the interaction of the liquor ingredients with the substrate and the soil and stains upon it.

In an embodiment, the applicants prefer that the enzyme-containing additive for washing or cleaning according to the present invention is also an aqueous composition, i.e. being based on the same carrier as the washing liquor is based on. This means that both the additive and the liquor would be water-based. This brings the advantage that the additive may readily be diluted and/or mixed into a liquor for washing or cleaning in which water is the continuous phase.

The additive according to the present invention may have another liquid than water as the continuous phase. Suitable and possibly preferred candidates are ethylene glycol, other glycols and/or polyols, or other liquids that are known to stabilize enzymes. The advantage is that the carrier also serves as a stabilizer for the enzymes in the additive composition.

The enzymes for use in washing processes are made commercially available as liquid concentrates of particular individual enzymes and/or of a mixture of a low number of particular enzymes. The concentration of the particular enzyme itself in the offered liquid product is proprietary information of the concentrate supplier. The concentrate that is sold further always contains at least one stabiliser such as ethylene glycol or other glycols or polyols. Due to these stabilisers, the enzymes in the concentrate are not active, kind of “dormant”, but stable. It is only when the concentrate is significantly diluted, such as when the concentrate is added into the washing process, that the inhibition effect brought by the stabiliser disappears and that the enzyme becomes active.

As a result of this confidentiality on the actual enzyme concentration in the commercially available enzyme concentrates, the industry has adopted a practice to express the enzyme levels in terms of how much of the particular enzyme concentrate that has been added into the formulation as a liquid. This document applies that same practice and expresses the concentration of the enzyme concentrates in the additive and/or in the washing liquor taking into account the total enzyme concentrate in its liquid form, and hence on a wet basis.

Enzymes are for 100% composed of proteins. In liquid enzyme concentrates, typically all of the proteins present are enzymes, but there is never an unambiguous assurance that all the proteins in the enzyme concentrates are necessarily present as enzymes. An upper limit on the total protein concentration of a composition therefore provides an upper limit on the total enzyme presence in that composition. The total protein content of an enzyme concentrate may readily be determined by means of the so-called bicinchoninic acid assay (in short “BCA assay”), also known as the Smith assay and well-known in the art. The protein concentration in a commercially available concentrate is therefore publicly available, and cannot be claimed as being information proprietary to the supplier. The typical protein levels in commercial enzyme concentrates are in the range of 5-10% wt.

The actual concentration of a particular active enzyme in a commercial enzyme concentrate product is by most producers treated as confidential information proprietary to the supplier. In order to enable the client to obtain particular product labels however, this information may need to be supplied to the issuing authorities. The customer using the concentrate may thus be informed in a more detailed manner about the composition of the enzyme concentrates that he obtains from the supplier, but he is not at liberty to disclose that information to the public.

It is generally known and accepted by the person skilled in the art that the proteins in the liquid enzyme concentrate may contain a small residue of proteins which are not present as enzymes. This residue is typically not taken into account when formulating a liquid enzyme concentrate. As is standard practice in the industry, this document will for the purpose of formulating liquid enzyme concentrates, assume that the amount of active enzymes in a sample of a liquid enzyme concentrate, corresponds or coincides with the calculated or measured amount of proteins in that sample.

The alkyl polyglycoside surfactant is the result of an etherification of an alcohol, typically a fatty alcohol, with at least one alcohol function of the sugar-based hydrophilic part of the compound. During the etherification step the other available alcohol groups on the glucose part also engage into etherification reactions, thereby forming a “polymeric” compound, which is why the final product is called a “polyglycoside”. The compound is typically a derivative of fat for the alcohol and lipophilic part, and of starch for the hydrophilic part of the compound. When the sugar-based starting material is essentially only glucose, the compound is named an alkyl polyglucoside.

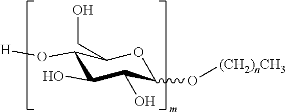

Molecular structure of alkyl polyglucoside, wherein m=the degree of polymerisation.

The concentration of the enzyme concentrates in the detergent formulation may be very broad. In the ultimate washing liquor, the activity of a particular enzyme concentrate ingredient may already be observed at a level of 1 ppm by weight. The inventors prefer to typically use a concentration of up to about 250 ppm by weight per enzyme concentrate in the washing liquor. The inventors further prefer to adjust the enzyme cocktail in the additive formulation and in the washing liquor to the amount and types of soil that are expected in the substrate to be treated.

The concentration of a particular enzyme concentrate as part of the additive according to the present invention may be derived from the recipe that has been followed for the production of the additive. A direct measurement of the amount of an individual enzyme in the additive according to the present invention is less straightforward because with an activity test (i) only the active enzymes are participating and (ii) it is difficult to exclude the effect of other ingredients in the additive on the activity of the enzyme for which is tested.

The total protein content in a composition such as the additive according to the present invention as well as in the enzyme concentrates that are used for its preparation may be determined directly by means of the so-called bicinchoninic acid assay (in short “BCA assay”), also known as the Smith assay and well-known in the art. The analytical technique is a biochemical assay for determining the total concentration of protein in a solution. The total protein concentration is exhibited by a colour change of the sample solution from green to purple in proportion to protein concentration, which may then be measured using colorimetric techniques. As is standard practice in the industry, this document will for the purpose of formulating liquid enzyme concentrates, assume that the amount of active enzymes in a sample of a liquid enzyme concentrate, corresponds or coincides with the calculated or measured amount of proteins in that sample.

The concentration of the at least one amine oxide, may readily be determined by High Performance Liquid Chromatography (HPLC). Also the concentration of other surfactants, such as the non-ionic surfactant and/or the alkyl polyglycoside, may readily be determined using this analytical technique.

The amine oxide is preferably the oxide of a tertiary amine (R₃N⁺—O⁻), more preferably an alkyl dimethyl amine oxide, even more preferably lauryl dimethyl amine oxide (CAS 1643-20-5). Although this amine oxide is known as a high foaming surfactant, the inventors have found that the foaming may be kept acceptable by correct dosing of the amine oxide depending on the type and amounts of soil on the substrate. High soil levels, especially particulate soil types, may suppress the foaming of a washing liquor.

In an embodiment, the additive according to the present invention comprises the at least one lipase enzyme concentrate at a concentration of at least 0.2% wt, preferably at least 0.5% wt, more preferably at least 1.0% wt, even more preferably at least 2.5% wt, preferably at least 5.0% wt, more preferably at least 7.0% wt, even more preferably at least 8.0% wt, preferably at least 9.0% wt, more preferably at least 10.0% wt, even more preferably at least 11.0% wt, preferably at least 12.0% wt, more preferably at least 15% wt of the at least one lipase enzyme concentrate. Optionally the additive comprises at most 50% wt of the at least one lipase enzyme concentrate, preferably at most 45%, more preferably at most 40%, even more preferably at most 35%, yet more preferably at most 30%, preferably at most 27.5%, more preferably at most 25%, even more preferably at most 22.5%, yet more preferably at most 20.0% wt, preferably at most 19.0%, more preferably at most 18.0%, even more preferably at most 17.0%, yet more preferably at most 16.0% wt, preferably at most 15.0%, more preferably at most 14.0%, even more preferably at most 13.0%, yet more preferably at most 12.0% wt. Additives for heavy duty services regarding fat stains may contain the lipase enzyme concentrate in a concentration in a range of 35 to 50% wt. Additives intended for lighter duty services for fat stains may contain the concentrate in a much lower concentration, such as in the range of 1.0 to 15% wt. Additives intended for other types of services, with only a very light duty fat functionality, may contain even lower concentrations of the lipase concentrate.

In an embodiment, the liquor according to the present invention comprises the at least one lipase enzyme concentrate at a concentration of at least 10 ppm wt, preferably at least 20 ppm wt, more preferably at least 50 ppm wt, even more preferably at least 100 ppm wt, preferably at least 150 ppm wt, more preferably at least 200 ppm wt of the at least one lipase enzyme concentrate. Optionally the additive comprises at most 500 ppm wt of the at least one lipase enzyme concentrate, preferably at most 450 ppm wt, more preferably at most 400 ppm wt, even more preferably at most 350 ppm wt, yet more preferably at most 300 ppm wt, preferably at most 250 ppm wt, more preferably at most 200 ppm wt, even more preferably at most 150 ppm wt. Liquors for heavy duty services regarding fat stains may contain the lipase enzyme concentrate in a concentration in a range of 150-500 ppm wt. Liquors intended for lighter duty services for fat stains may contain the concentrate in a much lower concentration, such as in the range of 25 to 250 ppm wt. Liquors intended for other types of services, with only a very light duty fat functionality, may contain even lower concentrations of the lipase concentrate.

In an embodiment, the liquor according to the present invention comprises the at least one protease enzyme concentrate at a concentration of at least 5 ppm wt, preferably at least 10 ppm wt, more preferably at least 50 ppm wt, even more preferably at least 100 ppm wt, preferably at least 150 ppm wt, more preferably at least 200 ppm wt of the at least one protease enzyme concentrate. Optionally the additive comprises at most 600 ppm wt of the at least one protease enzyme concentrate, preferably at most 500 ppm wt, more preferably at most 400 ppm wt, even more preferably at most 350 ppm wt, yet more preferably at most 300 ppm wt, preferably at most 250 ppm wt, more preferably at most 200 ppm wt, even more preferably at most 150 ppm wt. Liquors for heavy duty services regarding protein stains, often blood stains, may contain the protease enzyme concentrate in a concentration in a range of 150-500 ppm wt. Liquors intended for lighter duty services for protein stains may contain the concentrate in a much lower concentration, such as in the range of 25 to 250 ppm wt. Liquors intended for other types of services, with only a very light duty protein functionality, may contain even lower concentrations of the lipase concentrate.

In an embodiment, the additive according to the present invention comprises the at least one amine oxide at a concentration in the range of at least 1% wt. Preferably the additive comprises the at least one amine oxide at a concentration of at least 1.00% wt, more preferably at least 1.20% wt, even more preferably at least 1.40% wt, yet more preferably at least 1.60% wt, preferably at least 1.80% wt, more preferably at least 2.00% wt, even more preferably at least 2.20% wt, yet more preferably at least 2.40% wt, preferably at least 2.60% wt, more preferably at least 2.80% wt, even more preferably at least 3.00% wt, yet more preferably at least 3.20% wt, preferably at least 3.40% wt, more preferably at least 3.60% wt, even more preferably at least 3.80% wt, yet more preferably at least 4.00% wt, preferably at least 4.20% wt. Optionally the additive comprises the at least one amine oxide at a concentration of at most 15.0% wt, preferably at most 14.0% wt, more preferably at most 13.0% wt, even more preferably at most 12.0% wt, yet more preferably at most 11.0% wt, preferably at most 10.0% wt, more preferably at most 9.0% wt, even more preferably at most 8.0% wt, yet more preferably at most 7.0% wt, preferably at most 6.0% wt, more preferably at most 5.0% wt, even more preferably at most 4.0% wt, yet more preferably at most 3.0% wt.

In an embodiment, the liquor according to the present invention comprises the at least one amine oxide at a concentration in the range of at least 1 ppm wt. Preferably the liquor comprises the at least one amine oxide at a concentration of at least 2 ppm wt, more preferably at least 3 ppm wt, even more preferably at least 4 ppm wt, yet more preferably at least 5 ppm wt, preferably at least 6 ppm wt, more preferably at least 7 ppm wt, even more preferably at least 8 ppm wt, yet more preferably at least 9 ppm wt, preferably at least 10 ppm wt, more preferably at least 12 ppm wt, even more preferably at least 14 ppm wt, yet more preferably at least 16 ppm wt, preferably at least 18 ppm wt, more preferably at least 20 ppm wt, even more preferably at least 25 ppm wt, yet more preferably at least 30 ppm wt, preferably at least 40 ppm wt. Optionally the liquor comprises the at least one amine oxide at a concentration of at most 200 ppm wt, preferably at most 150 ppm wt, more preferably at most 100 ppm wt, even more preferably at most 80 ppm wt, yet more preferably at most 60 ppm wt, preferably at most 50 ppm wt, more preferably at most 40 ppm wt, even more preferably at most 30 ppm wt, yet more preferably at most 25 ppm wt, preferably at most 20 ppm wt, more preferably at most 18 ppm wt, even more preferably at most 16 ppm wt, yet more preferably at most 15 ppm wt.

In an embodiment, the additive according to the present invention comprises total proteins at a concentration of at least 5 ppm by weight, preferably at least 10 ppm by weight, more preferably at least 20 ppm, even more preferably at least 25 ppm, yet more preferably at least 30 ppm, preferably at least 35 ppm, more preferably at least 40 ppm, even more preferably at least 45 ppm, yet more preferably at least 50 ppm by weight, preferably at least 55 ppm, more preferably at least 60 ppm, even more preferably at least 65 ppm, yet more preferably at least 70 ppm by weight, preferably at least 75 ppm, more preferably at least 80 ppm, even more preferably at least 90 ppm, yet more preferably at least 100 ppm by weight, preferably at least 150 ppm, more preferably at least 200 ppm, even more preferably at least 250 ppm, yet more preferably at least 300 ppm by weight, preferably at least 400 ppm, more preferably at least 500 ppm, even more preferably at least 600 ppm, yet more preferably at least 750 ppm by weight, preferably at least 1000 ppm, more preferably at least 1500 ppm, even more preferably at least 2000 ppm, yet more preferably at least 2500 ppm by weight. The total protein concentration in the additive may be higher if the additive is intended for being further diluted in order to obtain a washing liquor. If the additive is intended as an additive for preparing a washing and/or cleaning liquor by adding water, the formulation may contain 0.1% wt of total proteins, preferably at least 0.2% wt, more preferably at least 0.3% wt, even more preferably at least 0.4% wt, yet more preferably at least 0.5% wt, preferably at least 0.75% wt, more preferably at least 1.0% wt, even more preferably at least 2.0% wt, yet more preferably at least 3.0% wt.

In an embodiment, the liquor according to the present invention comprises total proteins at a concentration of at least 10 ppm by weight, preferably at least 20 ppm by weight, more preferably at least 30 ppm, even more preferably at least 40 ppm, yet more preferably at least 50 ppm, preferably at least 60 ppm, more preferably at least 70 ppm, even more preferably at least 80 ppm, yet more preferably at least 90 ppm by weight, preferably at least 100 ppm, more preferably at least 150 ppm, even more preferably at least 200 ppm.

Without wanting to be bound by this theory, the applicants believe that the total concentration of proteins in a composition containing enzymes expresses an upper limit for the presence of enzymes in total in the composition. However, when the composition is prepared using fairly fresh enzyme concentrates, the total protein content of the composition may be considered as a fair representation of the total enzyme concentration in the composition. The applicants therefore believe that a higher total protein concentration typically corresponds with a higher concentration of active enzymes in the composition and hence also corresponds with a higher enzymatic activity of the detergent formulation itself or a derivative obtained from it.

Optionally the additive contains at most 10% wt of total proteins, preferably at most 9% wt, more preferably at most 8% wt, even more preferably at most 7% wt, yet more preferably at most 6% wt, preferably at most 5% wt, more preferably at most 4.0% wt, even more preferably at most 3.0% wt, yet more preferably at most 2.0% wt, preferably at most 1.5% wt, more preferably at most 1.0% wt, even more preferably at most 800 ppm by weight, yet more preferably at most 600 ppm by weight, preferably at most 500 ppm by weight, more preferably at most 400 ppm by weight, preferably at most 300 ppm by weight, yet more preferably at most 250 ppm by weight, preferably at most 200 ppm by weight, more preferably at most 150 ppm by weight, preferably at most 100 ppm by weight, yet more preferably at most 80 ppm by weight. The applicants prefer to comply with the upper limit to bring the benefit of improving the cost efficiency of the additive, and this without jeopardizing the effectiveness thereof. The applicants prefer to arrive at a suitable balance between the cost of the amounts of enzyme concentrates that are added into the additive and the effectiveness of the additive or of the derivative that may be produced therefrom by adding water.

Optionally the liquor contains at most 600 ppm wt of total proteins, preferably at most 550 ppm wt, more preferably at most 500 ppm wt, even more preferably at most 450 ppm wt, yet more preferably at most 400 ppm wt, preferably at most 350 ppm wt, more preferably at most 300 ppm wt, even more preferably at most 250 ppm wt, yet more preferably at most 200 ppm wt, preferably at most 150 ppm wt, more preferably at most 100 ppm wt, even more preferably at most 80 ppm by weight, yet more preferably at most 60 ppm by weight. The applicants prefer to comply with the upper limit to bring the benefit of improving the cost efficiency of the liquor, and this without jeopardizing the effectiveness thereof. The applicants prefer to arrive at a suitable balance between the cost of the amounts of enzyme concentrates that are added into the liquor, typically via a suitable additive, and the effectiveness of the liquor.

In an embodiment, the additive according to the present invention comprises the optional at least one non-ionic surfactant at a concentration of at most 20.0% wt, preferably at most 19.0% wt, more preferably at most 18.0% wt, even more preferably at most 17.0% wt, yet more preferably at most 16.5% wt, preferably at most 16.0% wt, more preferably at most 15.0% wt, even more preferably at most 14.0% wt, yet more preferably at most 13.0% wt, preferably at most 12.5% wt, more preferably at most 12.0% wt, even more preferably at most 11.0% wt, yet more preferably at most 10.0% wt, preferably at most 9.0% wt, more preferably at most 8.0% wt, even more preferably at most 7.0% wt, yet more preferably at most 6.5% wt, preferably at most 6.0% wt, more preferably at most 5.5% wt, even more preferably at most 5.0% wt, yet more preferably at most 4.5% wt, preferably at most 4.0% wt, more preferably at most 3.5% wt, even more preferably at most 3.0% wt, yet more preferably at most 2.5% wt, preferably at most 2.0% wt, more preferably at most 1.5% wt, even more preferably at most 1.0% wt, yet more preferably at most 0.5% wt and optionally at least 50 ppm by weight, preferably at least 100 ppm, more preferably at least 200 ppm, even more preferably at least 250 ppm, yet more preferably at least 300 ppm, preferably at least 400 ppm, more preferably at least 500 ppm, even more preferably at least 600 ppm, yet more preferably at least 700 ppm by weight, preferably at least 1000 ppm by weight or 0.1% wt, more preferably at least 0.2%, even more preferably at least 0.3%, yet more preferably at least 0.4%, preferably at least 0.5%, more preferably at least 0.6%, even more preferably at least 0.7%, yet more preferably at least 0.8%, preferably at least 0.9%, more preferably at least 1.0%, even more preferably at least 1.25%, yet more preferably at least 1.50%, preferably at least 2.00%, more preferably at least 2.5%, even more preferably at least 3.0%, yet more preferably at least 4.0%, preferably at least 5.0%, more preferably at least 6.0%, even more preferably at least 7.0%, yet more preferably at least 8.0%. For the liquor according to the present invention, these concentrations should be converted by dividing them by a factor 2000.

In an embodiment, the additive according to the present invention comprises the optional total of surfactants other than amine oxide and non-ionic surfactant at a concentration in the range of 50 ppm by weight up to 5.0% wt, preferably at most 4.0% wt, more preferably at most 3.5% wt, even more preferably at most 3.0% wt, yet more preferably at most 2.5% wt, preferably at most 2.0% wt, more preferably at most 1.5% wt, even more preferably at most 1.0% wt, yet more preferably at most 0.5% wt and optionally at least 50 ppm by weight, preferably at least 100 ppm, more preferably at least 200 ppm, even more preferably at least 250 ppm, yet more preferably at least 300 ppm, preferably at least 400 ppm, more preferably at least 500 ppm, even more preferably at least 600 ppm, yet more preferably at least 700 ppm by weight, preferably at least 1000 ppm by weight or 0.1% wt. The applicants typically prefer to not have any intentionally added other surfactants present in the additive, because of the negative effects that these may have on the activity of at least one of the enzymes. But they have found that such other surfactants may unintentionally be introduced as ingredient from one of the components used for the preparation of the additive. The applicants have found that limited levels of such other surfactants, as specified here, may still be allowable and allow to still achieve the technical effects targeted with the present invention. For the liquor according to the present invention, these concentrations should be converted by dividing them by a factor 2000.

In an embodiment, the additive according to the present invention comprises the at least one protease enzyme concentrate at a concentration of at least 0.2% wt, preferably at least 0.5% wt, more preferably at least 1.0% wt, even more preferably at least 2.5% wt, preferably at least 5.0% wt, more preferably at least 7.0% wt, even more preferably at least 8.0% wt, preferably at least 9.0% wt, more preferably at least 10.0% wt, even more preferably at least 11.0% wt, preferably at least 12.0% wt, more preferably at least 15% wt of the at least one protease enzyme concentrate. Optionally the additive comprises at most 50% wt of the at least one protease enzyme concentrate, preferably at most 45%, more preferably at most 40%, even more preferably at most 35%, yet more preferably at most 30%, preferably at most 27.5%, more preferably at most 25%, even more preferably at most 22.5%, yet more preferably at most 20.0% wt, preferably at most 19.0%, more preferably at most 18.0%, even more preferably at most 17.0%, yet more preferably at most 16.0% wt, preferably at most 15.0%, more preferably at most 14.0%, even more preferably at most 13.0%, yet more preferably at most 12.0% wt. For heavy duty services, the additive may comprise even higher levels of the protease concentrate. In an embodiment, the additive may comprise as much as 80% wt of the protease concentrate, preferably at most 75%, more preferably at most 70%, yet more preferably at most 65%, preferably at most 60%, more preferably at most 60% and even more preferably at most 55% of the at least one protease concentrate.

In an embodiment, the additive according to the present invention comprises the at least one protease enzyme concentrate in a weight ratio to the at least one lipase enzyme concentrate in the range of at least 0.1 to at most 10.0, preferably at least 0.25, more preferably at least 0.5, even more preferably at least 0.7, preferably at least 0.8, more preferably at least 0.9, even more preferably at least 0.95, yet more preferably at least 1.00, preferably at least 1.05, more preferably at least 1.10, even more preferably at least 1.2. Optionally the weight ratio of the protease enzyme concentrate relative to the lipase enzyme concentrate is at most 9.5, preferably at most 9.0, more preferably at most 8.0, even more preferably at most 6.0, preferably at most 5.0, more preferably at most 4.0, even more preferably at most 3.0, yet more preferably at most 2.0, preferably at most 1.50, more preferably at most 1.25, even more preferably at most 1.05, preferably at most 0.95, more preferably at most 0.90, even more preferably at most 0.85. The applicants have found that the compliance with this weight ratio range brings the advantage of an improved combined performance of the two kinds of enzymes, and hence an improved washing and/or cleaning performance.

In an embodiment, the additive according to the present invention is an aqueous composition. The applicants have found that an additive that is based on water as its continuous phase more readily mixes into the aqueous washing liquor, and more quickly forms a homogeneous liquor composition which is ready for exhibiting its desired optimum performance. The applicants have found that water also has a highly suitable viscosity and therefore may readily be pumped and passed through control valves and other equipment items. The applicants have further found that the choice for water as the basis for the additive, due to many alternatives being organic liquids, also avoids that the carrier of the additive would increase the environmental load of the washing and/or cleaning operation in which the additive is intended to be used. The choice for water thus also avoids an increase in the chemical oxygen demand (also called “COD”) and the biological oxygen demand (also called “BOD”) of the waste water discarded by the operation using the additive, and hence also avoids an increase in the taxes due for its emissions.

In an embodiment, the additive according to the present invention further comprises at least one amylase enzyme concentrate, preferably at a concentration that is in a weight ratio to the concentration of the at least one lipase enzyme concentrate of at least 0.1 to 2.0. Preferably the weight ratio of the amylase enzyme concentrate relative to the lipase enzyme concentrate is at least preferably at least 0.20, more preferably at least 0.25, even more preferably at least 0.3, preferably at least 0.4, more preferably at least 0.5, even more preferably at least 0.55, yet more preferably at least 0.60, preferably at least 0.70. Optionally the weight ratio of the amylase enzyme concentrate relative to the lipase enzyme concentrate is at most 1.75, preferably at most 1.5, more preferably at most 1.25, even more preferably at most 1.1, preferably at most 1.0, more preferably at most 0.90, even more preferably at most 0.80, yet more preferably at most 0.70, preferably at most 0.60, more preferably at most 0.55, even more preferably at most 0.50, preferably at most 0.45, more preferably at most 0.40, even more preferably at most 0.35. The presence of the amylase enzyme brings the benefit that the additive is also active against stains of saccharides, such as starch. The applicants have further found that the compliance with this weight ratio range brings the advantage of an improved combined performance of the two kinds of enzymes, and hence an improved washing and/or cleaning performance. The applicants have found that the presence of the amylase concentrate allows a reduction of the surfactant levels that are typically used in a washing process. The applicants have also found that the amylase concentrate may allow a more efficient and effective cleaning and/or washing of specific stains which may be very difficult to remove by other means.

In an embodiment, the additive according to the present invention further comprises at least one cellulase enzyme concentrate, preferably at a concentration that is in a weight ratio to the concentration of the at least one lipase enzyme concentrate of at least 0.05 to 1.5. Preferably the weight ratio of the cellulase enzyme concentrate relative to the lipase enzyme concentrate is at least preferably at least 0.10, more preferably at least 0.15, even more preferably at least 0.20, preferably at least 0.25, more preferably at least 0.3, even more preferably at least 0.35, yet more preferably at least 0.40, preferably at least 0.50. Optionally the weight ratio of the cellulase enzyme concentrate relative to the lipase enzyme concentrate is at most 1.45, preferably at most 1.25, more preferably at most 1.10, even more preferably at most 1.00, preferably at most 0.90, more preferably at most 0.80, even more preferably at most 0.70, yet more preferably at most 0.60, preferably at most 0.50, more preferably at most 0.40, even more preferably at most 0.30, preferably at most 0.25, more preferably at most 0.20, even more preferably at most 0.15. The presence of the cellulase enzyme brings the benefit that the additive is also active in breaking down walls or organic cells, such as the construction elements of most biological specimens, single cellular and multicellular, and which thus includes all possible living creatures ranging from bacteria up to plants and meat, and hence may be key in breaking down bacteria but also rests of plants, shellfish, fish, meat, up to rests of human tissue. The applicants have further found that the compliance with this weight ratio range brings the advantage of an improved combined performance of the two kinds of enzymes, and hence an improved washing and/or cleaning performance.

In an embodiment, the additive according to the present invention comprises no surfactant other than the at least one amine oxide, except for surfactants that may have been present in the ingredients used for preparing the additive. The applicants have found that many surfactants other than the at least one amine oxide may have a tendency to reduce the activity of the lipase enzyme when the additive is used in the context of a washing and/or cleaning operation. Without wanting to be bound by this theory, the applicants believe that this effect on the activity of a lipase enzyme may be due to the surfactant having also an affinity for the fat containing stain and may thus be in competition with the lipase enzyme for accessing the stain, thereby reducing the contact opportunities between the lipase enzyme and the fat containing stain.

In an embodiment, the additive according to the present invention further comprises at least one enzyme stabilizing system. Such at least one enzyme stabilizing system may for instance be comprising a boric acid salt, such as an alkali metal borate or amine (e.g. an alkanol amine) borate, or a borate ester, e.g. 4-formylphenylboronic acid (4FPBA), or potassium borate, or a phenyl boronic acid derivative such as described in WO 96/41859 (A1). More preferably the at least one enzyme stabilizing system further comprises a water soluble source of calcium and/or magnesium ions such as described in EP 3137235 B1. Boron-free enzyme stabilizing systems may for instance comprise ethylene glycol or other glycols or polyols. Many enzyme stabilizing systems may comprise at least one component selected from sodium formate and a peptide aldehyde or a hydrosulphite adduct thereof, the peptide aldehyde or its adduct preferably in combination with a salt of a monovalent cation, usually a calcium cation, and/or a monovalent organic anion (such as the ones disclosed in EP 2726590 B1). The applicants have found that at least one enzyme stabilizing system may contribute to a longer shelf life of the additive, meaning that the additive may over a longer period of time maintain its capability of delivering as much as possible of the expected performance. This means that the additive must not be used shortly after its preparation but may be put to use a period of time after its moment of preparation. The additive may thus be stored and/or transported after its preparation.

In an embodiment, the additive according to the present invention further comprises at least one hardness increasing compound, preferably a compound capable of liberating calcium and/or magnesium cations in an aqueous environment, preferably the water hardness increasing compound being selected from a calcium salt, a magnesium salt, and combinations thereof. Practically all salts of calcium and/or magnesium are suitable, including oxides, hydroxides, sulphates, nitrates, carbonates, bicarbonates, chlorides, formates, acetates, and the like. The applicants have surprisingly found that the lipase enzyme exhibits an even higher activity in a liquor containing a water hardness increasing compound, as compared to a liquor based on water having a low mineral content, also known as “soft water”. In order to assure the beneficial effect is achieved with the liquor prepared from the additive, the applicants prefer to add the water hardness increasing compound already into the additive. The amount of hardness increasing compound should be targeted to raise the water hardness of the washing and/or cleaning liquor derived from the additive with at least 2° fH, preferably at least 3° fH, more preferably at least 4° fH, even more preferably at least 5, 6 or even 7° fH.

In an embodiment of the additive according to the present invention, the at least one amine oxide is the oxide of a tertiary amine, preferably an alkyl dimethyl amine oxide, more preferably the alkyl dimethyl amine oxide comprising lauryl dimethyl amine oxide and preferably substantially being lauryl dimethyl amine oxide. The applicants have found that this choice of amine oxide is highly suitable for obtaining the advantageous effects of the present invention. The applicants have also found that the selected amine oxides are also more readily available in the desired quantities and in a quality that is most suitable for use in the context of the present invention.

In an embodiment, the additive according to the present invention comprises the second surfactant and the second surfactant is an ethoxylated and/or propoxylated surfactant, preferably the surfactant having an average degree of alkoxylation that is at most 9, more preferably at most 8, even more preferably at most 7, preferably at most 6, more preferably at most 5, and even more preferably at most 4. The applicants have found that the presence of the specified non-ionic surfactant may be acceptable in the additive and that the beneficial effect of the present invention remains achievable in the presence thereof. The presence of the second surfactant brings the advantage that the surfactant may contribute to the washing and/or cleaning performance of the additive, in particular when the additive is used as part of a washing and/or cleaning liquor. When the additive is intended for being added to a washing or cleaning liquor, the applicants prefer to dose the specified non-ionic surfactant in the additive such that its concentration in the washing or cleaning liquor becomes at most 500 ppm by weight, preferably at most 400 ppm by weight. These high concentrations may be preferred when the liquor is intended for heavy duty service, such as for washing heavily soiled textiles. The applicants have found that under these circumstances the additive is still capable of demonstrating the beneficial effect of the present invention. For lighter duty services of the liquor, the applicants prefer to target a lower concentration of the specified non-ionic surfactant, such as at most 350 ppm by weight, preferably at most 300 ppm by weight, more preferably at most 250 ppm by weight, even more preferably at most 200 ppm by weight, preferably at most 150 ppm by weight, and more preferably at most 100 ppm by weight. The applicants have found that the beneficial effect of the present invention may under these circumstances of a lower presence of the second surfactant be even more pronounced.

In an embodiment, the additive according to the present invention comprises the second surfactant and the second surfactant is at least one alkyl polyglycoside, wherein the alkyl polyglycoside is an alkyl polyglucoside, preferably a C8-10 alkyl polyglucoside. The applicants have found that the alkyl polyglycoside exhibits a much lower effect on the activity of the lipase enzyme, if any at all. The applicants have found that the advantageous effect of the present invention is much less impaired or reduced by the presence of the alkyl polyglycoside, and that in many circumstances no negative effect may be noticed at all that may be associated with the presence of the alkyl polyglycoside. The applicants have found that the dosing of the alkyl polyglycoside in the additive, and downstream into the washing and/or cleaning liquor, may be in a much wider range of concentrations as compared to the ethoxylated and/or propoxylated surfactant discussed elsewhere in this document as a candidate second surfactant. In the embodiment wherein the additive according to the present invention comprises at least one alkyl polyglycoside as the second surfactant, the additive comprises the at least one alkyl polyglycoside in a concentration range of at least 1000 ppm by weight and at most 25% wt, preferably at least 0.25, 0.50, 0.75, 1.00, 1.50% wt, and optionally at most 22, 20, 27.5, 15.0, 10.0, 7.5, 5.0, or 4.0% wt.

In an embodiment of the additive according to the present invention, the alkyl polyglycoside has an average degree of polymerisation of at most 4, preferably at most 2.5, more preferably at most 1.5. The applicants have found that the specified alkyl polyglycoside is most suitable for use in the context of the present invention, because it brings the better balance between performance as a surfactant in the washing and/or cleaning liquor and any effect it may possibly bring to the activity of the enzymes in the compositions, in particular of the lipase enzyme.

In an embodiment, the additive according to the present invention comprises the second surfactant in a concentration of at most 25% wt. Preferably the additive comprises the second surfactant in a concentration of at least 1.00% wt, more preferably at least 1.25% wt, even more preferably at least 1.50% wt, preferably at least 1.75% wt, more preferably at least 2.00% wt, even more preferably at least 2.25% wt, preferably at least 2.50% wt, more preferably at least 2.75% wt, even more preferably at least 3.00% wt. The applicants have found that an additive comprising the second surfactant in the hereinbefore specified range is very suitable for preparing a washing liquor suitable for washing lightly soiled textiles. In another embodiment, the additive comprises the second surfactant at a concentration of at least 5% wt, preferably at least 7.50% wt, more preferably at least 10.00% wt, even more preferably at least 12.50% wt, preferably at least 15.00% wt, more preferably at least 17.50% wt, even more preferably at least 20.00% wt. The applicants have found that an additive comprising the second surfactant at this higher level is very suitable for preparing a washing liquor suitable for washing heavily soiled textiles, including even slaughterhouse textiles. Optionally the additive comprises the second surfactant at a concentration of at most 23% wt, preferably at most 20.00% wt, more preferably at most 18.00% wt, even more preferably at most 16.00% wt, preferably at most 14.00% wt, more preferably at most 12.00% wt, even more preferably at most 8.00% wt, preferably at most 6.00% wt, more preferably at most 5.00% wt, even more preferably at most 4.00% wt. Complying with the upper limit as specified brings the advantage that any possible partial hindering effect of the second surfactant on the enzyme activity remains limited, such that the beneficial effect of the present invention may be optimised in balance with the beneficial effect of having the second surfactant present in the additive, and in the downstream liquor derivative.

In an embodiment, the liquor according to the present invention is obtained by adding water and/or at least an other liquid such as ethylene glycol, other glycols and/or polyols, or other liquids that are known to stabilize enzymes to the additive, preferably using at least partly water that is discarded from a rinsing step upstream or downstream of a washing step as part of a washing or cleaning cycle. The applicants have found that a suitable liquor for washing or cleaning, or at least a highly suitable intermediate therefore, may readily be obtained by adding water to the additive according to the present invention. Preferably the applicants reuse water that was already used at least once in a rinsing step. The applicants have found that the quality of water that was already used at least once in a rinsing step is usually still acceptable for being added to the additive. The applicants realise that such rinse water may still contain surfactants that were used in the washing or cleaning step upstream of the rinsing step, but they have also found the levels of these surfactants is typically sufficiently low such that the activity of the enzymes contributed by the additive according to the present invention still remains sufficiently high. Preferably the applicants use water obtained from a rinsing step that is part of the washing or cleaning process in which an additive according to the present invention and/or a liquor according to the present invention has been used. This brings the advantage that the kind of surfactants that may be present in the water from the rinsing step is the same as the surfactants that the enzymes will encounter that are introduced into the washing or cleaning process by the additive according to the present invention. Typically these surfactants have been selected knowing which enzymes are present in the additive. The applicants have found that this reduces the risk for a problem of incompatibility between the selection of the enzymes and the surfactants returning with the water from the rinsing step.

Into the liquor according to the present invention may further be introduced other ingredients, such as extra surfactants, such as further non-ionic surfactants, biocides, acids, builders, dispersing agents, soil release polymers, acrylates, antistatic agents, buffering agents, foaming control agents, optical brightening agents, dyestuffs, solvents, pH-adjusting agents, such as alkali, etcetera.

In an embodiment, the liquor according to the present invention is suitable for in an industrial washing process, preferably in a textile or laundry washing process, more preferably in a prewash step part of the washing process, or for cleaning in place (also called “CIP”) or for hard surface cleaning. The applicants have found that the liquor according to the present invention is highly suitable for a large number of washing and/or cleaning operations, in particular for removing fat or triglyceride stains thanks to the high activity of the lipase enzyme in the liquor and/or in the additive.

In an embodiment, the liquor according to the present invention comprises the second surfactant in a concentration of at most 400 ppm by weight, preferably at most 375 ppm, more preferably at most 360 ppm, even more preferably at most 350 ppm by weight, preferably at most 340 ppm, more preferably at most 330 ppm, even more preferably at most 320 ppm. The applicants have found that the specified upper limit allows for sufficient presence of the second surfactant in the liquor while avoiding that the second surfactant would have an excessive negative effect on the activity of the lipase enzyme and thus excessively reduce the beneficial effect of the present invention. The applicants have even found that the prescribed upper limits still allow that the liquor is suitable for heavy duty washing and cleaning operations, such as for in the washing of heavily soiled textiles, which may e.g. be slaughterhouse textiles. The applicants have found that with an alkyl polyglycoside (APG) as the second surfactant higher concentrations are allowable as compared to an ethoxylated and/or propoxylated surfactant as the second surfactant, because the applicants have found that the APG hardly has any negative effect on the activity of the lipase enzyme in the washing or cleaning process.

In an embodiment, the liquor according to the present invention comprises the second surfactant in a concentration of at most 150 ppm by weight, preferably at most 140 ppm, more preferably at most 130 ppm, even more preferably at most 125 ppm by weight, preferably at most 120 ppm, more preferably at most 110 ppm, even more preferably at most 100 ppm. The applicants have found that compliance with this upper limit allows for an even higher beneficial effect of the present invention, in particular if the second surfactant is an ethoxylated and/or propoxylated surfactant, because of a reduced competition between the surfactant and the lipase enzyme for gaining access to the fat stains that one intends to remove. Compliance with this upper limit is thus more preferred with an ethoxylated and/or propoxylated surfactant as the second surfactant, and may readily be considered less important with APG as the second surfactant. The applicants have found that a liquor having the second surfactant in the range that is specified here makes the liquor highly suitable for lighter duty services, such as for washing lightly soiled textiles or for cleaning lightly soiled surfaces.

In an embodiment, the liquor according to the present invention comprises no surfactant other than the amine oxide, except for surfactants that may have been present in the ingredients used for preparing the liquor. Ingredients other than the additive may also contain surfactants. For instance the water that may be used as the basis for the liquor may be discard water from a rinsing step, and this water may contain some of the surfactants that were used in the washing or cleaning step upstream of the rinsing step, albeit usually at a lower concentration as compared to in the liquor that was used in the upstream washing or cleaning step. Other ingredients of the washing or cleaning liquor may also contain surfactants, e.g. in order to keep an active ingredient in emulsion or in suspension. These extra surfactants are in this embodiment of the present invention considered unavoidable impurities, because they are not intentionally added to the liquor, and its presence does not have as prime purpose a contribution to the washing and/or cleaning performance of the liquor. The applicants prefer in this embodiment to have no surfactant other than the amine oxide to be present in the liquor because this brings the advantage that the lipase enzyme encounters much less, and preferably no competition for gaining access to the fat stains the liquor is supposed to remove, and hence the lipase enzyme may exhibits its full activity, which is in addition typically boosted by the presence of the amine oxide.

In an embodiment, the liquor according to the present invention further comprises at least one amylase enzyme concentrate, preferably at a concentration that is in a weight ratio to the concentration of the at least one lipase enzyme concentrate of at least 0.1 to 2.0. This brings the advantage that the liquor is also effective in attacking stains containing saccharides, including but more importantly di- and trisaccharides, and also higher polymeric saccharides up to starch. In that way, amylase enzymes contribute to a washing or cleaning process by “dissolving” starches that have soiled fabrics, dishes and other hard surfaces. Different types of amylase enzymes are known, such as alpha-, beta- and gamma-amylase, and these have their own range of preferential targets. The detergent formulator may thus be able to select the more he is planning for. The applicants prefer to have the amylase enzyme concentrate present at a ratio relative to the concentration of the at least one lipase enzyme concentrate of at least 0.20, preferably at least 0.25, more preferably at least 0.30, even more preferably at least 0.40, yet more preferably at least 0.50. Optionally the applicants want the amylase enzyme concentrate to be present at the ratio relative to the concentration of the at least one lipase enzyme concentrate of at most 1.75, preferably at most 1.50, more preferably at most 1.25, even more preferably at most 1.15, preferably at most 1.00, more preferably at most 0.75, even more preferably at most 0.60. The applicants have found that the amylase presence may be kept limited while the enzyme is fully capable of bringing its contribution to the washing or cleaning operation. The advantage is that no excess of the amylase enzyme concentrate is used. Because the concentrate is rather difficult to produce it is also not that readily available. The applicants therefore prefer to also comply with the upper limit as specified in this paragraph.

In an embodiment, the liquor according to the present invention further comprises at least one cellulase enzyme concentrate, preferably at a concentration that is in a weight ratio to the concentration of the at least one lipase enzyme concentrate of at least 0.05 to 1.5. This brings the advantage that the liquor is also effective in attacking stains containing cellulose. But even more importantly the cellulase enzyme also brings a beneficial fabric effect, and hence is highly suitable in the washing of textiles. The cellulase enzyme is able to degrade surface fibrils of biological fabrics, such as cotton, i.e. small fibres that extend from the fabric and give the fabric some roughness. By degrading these fibrils during a washing process, the cellulase enzyme is thus able to bring a smoothening effect on the washed fabric. Further benefits is that the use of cellulase enzyme in the washing or cleaning process prevents dirt particles in the wash water from depositing on otherwise clean fabrics. The cellulase enzyme thus brings improved performance on whiteness and brightness, even when used at ambient temperatures. The applicants prefer to have the cellulase enzyme concentrate present at a ratio relative to the concentration of the at least one lipase enzyme concentrate of at least 0.10, preferably at least 0.15, more preferably at least 0.20, even more preferably at least 0.25, yet more preferably at least 0.30. Optionally the applicants want the cellulase enzyme concentrate to be present at the ratio relative to the concentration of the at least one lipase enzyme concentrate of at most 1.25, preferably at most 1.00, more preferably at most 0.75, even more preferably at most 0.50, preferably at most 0.30, more preferably at most 0.25, even more preferably at most 0.20. The applicants have found that the cellulase presence may be kept limited while the enzyme is fully capable of bringing its contribution to the washing or cleaning operation. The advantage is that no excess of the cellulase enzyme concentrate is used. Because the concentrate is rather difficult to produce it is also not that readily available. The applicants therefore prefer to also comply with the upper limit as specified in this paragraph.

In an embodiment, the liquor according to the present invention further comprises at least one enzyme concentrate containing at least one enzyme that is selected from the group consisting of mannase, mannanase, pectin lyase, pectolyase, β-glucanase, hemicellulase, catalase. These extra enzymes bring the advantage that they bring their own specific contribution to the washing and/or cleaning operation because of their specific activity against particular stains, or against a part or an ingredient thereof.

In an embodiment, the liquor according to the present invention further comprises at least one enzyme stabilizing system. The applicants prefer the stabilizing system in the liquor to be present at a low concentration, such that the enzymes may exhibit their activity to their full extent. The enzyme stabilizing system may however be present in an ingredient that is used to form the liquor, in which the stabilizing system is desired for its functionality. The applicants prefer that such an ingredient of the liquor becomes sufficiently diluted by the other ingredients of the liquor, including water, such that the activity of the enzymes is not impaired by the stabilizing system. The applicants prefer to have in the liquor only the non-intentional presence of enzyme stabilizing systems. Such at least one enzyme stabilizing system may for instance be comprising a boric acid salt, such as an alkali metal borate or amine (e.g. an alkanol amine) borate, or a borate ester, e.g. 4-formylphenylboronic acid (4FPBA), or potassium borate, or a phenyl boronic acid derivative, such as described in WO 96/41859 A1. More preferably the at least one enzyme stabilizing system further comprises a water soluble source of calcium and/or magnesium ions, such as described in EP 3137235 B1. Boron-free enzyme stabilizing systems may for instance comprise ethylene glycol or other glycols or polyols. Many suitable enzyme stabilizing systems comprise at least one component selected from sodium formate and a peptide aldehyde or a hydrosulphite adduct thereof, the peptide aldehyde or its adduct preferably in combination with a salt of a monovalent cation and/or a monovalent organic anion (such as disclosed in EP 2726590 B1). The applicants have found that at least one enzyme stabilizing system may contribute to a longer shelf life of the additive, meaning that the additive may over a longer period of time maintain its capability of delivering as much as possible of the expected performance. This means that the additive must not be used shortly after its preparation but may be put to use a period of time after its moment of preparation. The additive may thus be stored and/or transported after its preparation. The applicants prefer an enzyme stabilizing system that is readily diluted with water, such as the glycols mentioned above, because stabilizing systems that mix well with water are easier to work with, readily dilute, and bring a low risk of impairing liquid flows, e.g. by forming solids.

The applicants however prefer that no enzyme stabilizing system is added intentionally to the washing liquor according to the present invention. Even more preferably, the applicants prefer to create the conditions that allow that the washing liquor according to the present invention comprises no enzyme stabilizing system at all, hence that also the enzyme containing additive that has been used in the formation of the washing liquor does not contain an enzyme stabilizing system. As explained further below in this document, these conditions may for instance be created when the additive is prepared on-site with the operation that is using the washing and/or cleaning liquor according to the present invention.

In an embodiment, the liquor according to the present invention further comprises at least one water hardness increasing compound, preferably a compound capable of liberating calcium and/or magnesium cations in an aqueous environment, preferably the water hardness increasing compound being selected from a calcium salt, a magnesium salt, and combinations thereof. Practically all salts of calcium and/or magnesium are suitable, including oxides, hydroxides, sulphates, nitrates, carbonates, bicarbonates, chlorides, formates, acetates and the like. The applicants have surprisingly found that the lipase enzyme exhibits an even higher activity in a liquor containing a water hardness increasing compound, as compared to a liquor based on water having a low mineral content, also known as “soft water”. The applicants prefer that the washing liquor should have a hardness expressed in French degrees (° fH) of at least 2° fH and at most 36° fH. Preferably the washing liquor should have a hardness of at least 3, 4, 5, 6 or 7° H. Optionally the hardness of the washing liquor should be at most 30, 25, 20, 15, 12, 10, or at most 8° fH.

In an embodiment of the liquor according to the present invention, the at least one amine oxide is the oxide of a tertiary amine, preferably an alkyl dimethyl amine oxide, more preferably the alkyl dimethyl amine oxide comprising lauryl dimethyl amine oxide and preferably substantially being lauryl dimethyl amine oxide. The applicants have found that the specified amine oxide is highly suitable and highly effective in obtaining the advantageous effect of the present invention.

In an embodiment of the liquor according to the present invention, the second surfactant is an ethoxylated and/or propoxylated surfactant, preferably the surfactant having an average degree of alkoxylation that is at most 9, more preferably at most 8, even more preferably at most 7, preferably at most 6, and optionally at least 5, preferably at least 6, more preferably at least 7, even more preferably at least 8. The applicants have found that the presence of the specified non-ionic surfactant may be acceptable in the liquor and that the beneficial effect of the present invention remains achievable in the presence thereof. The presence of the second surfactant brings the advantage that the surfactant may contribute to the washing and/or cleaning performance of the washing and/or cleaning liquor. The applicants prefer to dose the specified non-ionic surfactant in the liquor at a concentration of at most 500 ppm by weight, preferably at most 400 ppm by weight. These high concentrations may be preferred when the liquor is intended for heavy duty service, such as for washing heavily soiled textiles. The applicants have found that under these circumstances the liquor is still capable of demonstrating the beneficial effect of the present invention. For lighter duty services of the liquor, the applicants prefer to target a lower concentration of the specified non-ionic surfactant, such as at most 350 ppm by weight, preferably at most 300 ppm by weight, more preferably at most 250 ppm by weight, even more preferably at most 200 ppm by weight, preferably at most 150 ppm by weight, and more preferably at most 100 ppm by weight. The applicants have found that the beneficial effect of the present invention may under these circumstances of a lower presence of the second surfactant be even more pronounced.

The applicants have found that a highly preferred ethoxylated and/or propoxylated surfactant may most preferably be selected from the group consisting of ethoxylated isoC13 alcohol carrying on average about 5 ethylene oxide (EO) monomers and ethoxylated linear C13-C15 alcohol mixture carrying on average at least 5 ethylene oxide (EO) monomers.

In an embodiment of the liquor according to the present invention, the second surfactant is at least one alkyl polyglycoside, wherein the alkyl polyglycoside is an alkyl polyglucoside, preferably a C8-10 alkyl polyglucoside. The applicants have found that the alkyl polyglycoside exhibits a much lower effect on the activity of the lipase enzyme, if any at all, as compared to the alkoxylated second surfactant discussed elsewhere in this document. The applicants have found that the advantageous effect of the present invention is much less impaired or reduced by the presence of the alkyl polyglycoside, and that in many circumstances no negative effect may be noticed at all that may be associated with the presence of the alkyl polyglycoside. The applicants have found that the dosing of the alkyl polyglycoside in the washing and/or cleaning liquor, may therefore be in a much wider range of concentrations as compared to the ethoxylated and/or propoxylated surfactant discussed elsewhere in this document as a candidate second surfactant.

In an embodiment of the liquor according to the present invention containing the alkyl polyglucoside, the alkyl polyglycoside has an average degree of polymerisation of at most 4, preferably at most 2.5, more preferably at most 2.0, even more preferably at most 1.5. The applicants have found that the specified alkyl polyglycoside is highly suitable and highly effective in obtaining the advantageous effect of the present invention.

In an embodiment, the liquor according to the present invention comprises the second surfactant is present in a concentration of at most 1000 ppm by weight, preferably at most 750 ppm, more preferably at most 500 ppm, even more preferably at most 400 ppm by weight. The applicants have found that the levels as specified are suitable for a liquor intended for heavy duty service, such as in the washing of heavily soiled textiles, even including slaughterhouse textiles. In another embodiment, the liquor comprises the second surfactant in a concentration of at most 350 ppm by weight, preferably at most 300 ppm, more preferably at most 250 ppm, even more preferably at most 200 ppm by weight, preferably at most 150 ppm, more preferably at most 100 ppm, even more preferably at most 50 ppm by weight. The applicants have found that the levels as specified the latest are suitable for a liquor intended for light duty service, such as in the washing of lightly soiled textiles, while also the beneficial effect of the present invention may be optimised thanks to less competition between the second surfactant and the lipase enzyme in accessing the fat stains.

In an embodiment, the process according to the present invention is further comprising the step of adding at least one further ingredient selected from the at least one alkyl polyglycoside, the at least one amylase enzyme concentrate, the at least one cellulase enzyme concentrate, the at least one enzyme stabilizing system, and combinations thereof.

In an embodiment, the process according to the present invention is further comprising at least one washing or cleaning step wherein at least part of the additive is used as an active ingredient in the at least one washing or cleaning step.

In an embodiment of the process according to the present invention, the additive is prepared on-site with the washing or cleaning step that is using the at least part of the additive. This brings the advantage that the composition of the additive may be adapted to the specific task of the washing or cleaning step in which the additive is intended to be employed. The recipe of the additive may thus be adapted such that the additive is offering an optimal performance in the washing or cleaning step for which the additive is intended, and hence for each step served individually. This brings the advantage that the enzyme component may become an independent parameter in the washing process, because the choice of enzymes and their respective concentrations may become adapted individually to the washing and/or cleaning service for which that particular additive to be formed is intended. The applicants have found that this feature brings a highly appreciated advantage in improving the effectiveness as well as the efficiency of the washing and/or cleaning services that are being supplied to. Another advantage is that the additive may be freshly prepared shortly before the additive is employed. This brings the extra advantage that there is no need for a longer term stability of the additive, and that there is only a short time in which one ingredient of the additive may have an effect on the presence or performance of another ingredient. This further improves the effectiveness and the efficiency of the enzymes that are employed in the overall process. This brings also for instance the advantage that the protease enzyme has little to no time or chance to attack the lipase enzyme or another enzyme that may be present in the additive. A further advantage is that the additive composition may have little or only a small need for an enzyme stabilizing system. In many cases, the additive may be formulated without any enzyme stabilizing system, which brings the additional advantage that the activity of the different enzymes will not be impaired or reduced by any enzyme stabilizing system that would otherwise have been added for the purpose of increasing the stability of the additive itself.

In an embodiment of the process according to the present invention wherein water is used in the preparation of the additive, the water used is regular tap water available on the site where the additive is prepared. There are however alternatives possible, as explained herein below.

In an embodiment, the process according to the present invention further comprises at least one washing or cleaning step wherein at least part of the liquor according to the present invention is used in the washing or cleaning step.

In an embodiment of the process according to the present invention wherein a liquor is prepared using the additive according to the present invention, the liquor is prepared on-site with the washing or cleaning step that is using at least part of the liquor. This brings a number of significant advantages, in particular in an industrial and/or institutional framework where washing and cleaning operations are of a larger scale and more intense than in a consumer household, and where the priorities and sensitivities are also very different.

An important benefit of the present invention is an improvement in the safety and industrial hygiene on the site where the treatment device is located, but at the same time also on the location remote therefrom where in the conventional supply chain the detergent formulation used to be prepared and packaged, because the risk for exposure of personnel to enzyme-containing products, including aerosols thereof, is strongly reduced.

A further advantage of the on-site preparation is that the recipe of the detergent formulation that should be delivered to the treatment device may be tailor made and tuned finely to the requirements and desires of the client. The on-site preparation of the detergent formulation brings the possibility to adjust the individual dosing of the different enzyme concentrates and this independent of the dosing of any surfactant that may be part of the same detergent formulation. The close proximity in time and location between the preparation and the application of the detergent formulation allows to use the dosing of each individual one of the available enzyme concentrates as independent parameters in optimizing the cost and the performance of each one of the treatment devices supplied by the process according to the present invention. This dosing flexibility is not available in the conventional setting wherein the detergent formulation needs to be prepared off-site and transported to the site of consumption.

A further advantage is that the additive and the liquor may be freshly prepared shortly before the additive and/or liquor are employed. This brings the extra advantage that there is no need for a longer term stability of the additive and/or liquor, and that there is only a short time in which one ingredient of the composition may have an effect on the presence or performance of another ingredient. A further advantage is that the additive composition may have little or no need for any enzyme stabilizing system. In many cases, the products may be formulated without any intentionally added enzyme stabilizing system, which brings the additional advantage that the activity of the different enzymes will not be impaired or reduced by any enzyme stabilizing system that would otherwise have been added for the purpose of increasing the stability of the additive itself. The enzymes employed in the process may thus exhibit more of their potential, up to their full potential, which improves the effectiveness and the efficiency of the overall process. A further advantage is the avoidance of the extra burden by ant extra enzyme stabilizing system on the COD or BOD in the waste water from the treatment process.

The close proximity in time and location between the preparation of the formulation and the use thereof, also allows almost immediate feedback on the performance of the formulation, and hence allows a ready adjustment of the formulation to the substances for which the formulation is designed. The very quick feedback on the performance of a formulation after its preparation allows for further adjustments of the preparation recipe during subsequent preparation cycles of the same formulation. The formulation may thus be fully adapted to the intended use and the recipe may be adjusted based on the quick performance feedback. The types of enzymes in the formulation of the additive may be selected accordingly, as well as their respective dosing. Also the type and level of any of the surfactants in the formulation may be tuned to the intended use. The process according to the present invention therefore allow a close tailoring of the additive, as much as practically possible, to the service in which the formulation is intended to be used. The process therefore allow to avoid the inclusion in the formulation of enzymes that are not required, as well as avoiding any over- or underdosing of the enzymes relative to the performance which they are expected to deliver. The process according to the present invention therefore allows to reach an improved balance between the desires for effectiveness and efficiency of the enzyme-containing detergent formulation discussed before in this document.

Enzymes are introduced into washing and cleaning operations because of their high effectiveness. Only small amounts of the enzyme concentrates are required to deliver the same performance as much higher amounts of surfactants when only surfactants are used. The presence of the correct enzymes in the formulation thus allows to significantly reduce the amounts of surfactants that may still be needed in the washing or cleaning operations. The reduction in surfactant need reduces the costs of the detergent formulation, and because the surfactants end up in the waste water where the reduction in surfactant use contributes significantly to the reduction of the BOD and/or COD, and hence to the environmental tax that is levied by the authorities in return for a license to discard that water.

The on-site preparation of the additive allows its preparation in small batch quantities, such that they do not need to be stored long before consumption in the treatment device.

This brings the yet further advantage that the enzyme-containing additive may be prepared with little of any enzyme stabilizing system, preferably even without any. In the first place, those enzyme stabilisers or stabilizing systems are expensive ingredients for a detergent formulation. Secondly, some stabiliser systems may still have some inactivating effect on the enzymes in the formulation, even at the diluted concentrations in a washing liquor, and thus require the formulation to contain somewhat more of the target enzyme concentrates. And enzyme concentrates are by far the most expensive ingredient of a detergent formulation. Thirdly, the stabilisers in the additive finally end up in the waste water from the washing or cleaning operations that uses the formulation, where they increase the BOD and/or COD of the waste water, and hence also increase the taxes that governments demand for allowing the disposal of that waste water. The reduction and preferably the avoidance of any enzyme stabilizing system therefore contributes further to a reduction in the BOD and/or COD in the waste water from the treatment device, and hence to the environmental tax demanded in return for a license to discard that water.

In an embodiment of the process according to the present invention wherein water is used in the preparation of the liquor, at least a part of the used water, preferably all of the used water, is discard water from a rinsing step that is part of a washing or cleaning step, preferably of the washing or cleaning step that is using the at least part of the liquor. The applicants have found that water from a rinsing step is still suitable for being reused in the preparation of the liquor according to the present invention. The applicants have found that the level of surfactants that may still be present in the rinsing water discard is acceptably low, and hardly represents any disadvantage for the performance of the ingredients of the liquor. This reuse brings the advantage that the overall production of discard water from the entire washing or cleaning process is reduced. All discard waters from a washing or cleaning process are contaminated and contribute to the chemical and/or biological oxygen demand of the site where the washing or cleaning process is performed, for which the society and/or authorities may request or impose a financial compensation. The reuse of at least some of the water from a rinsing step in the preparation of the liquor may therefore represent a reduction of the cost of operating the overall washing or cleaning operation.

In an embodiment, the process according to the present invention is further comprising a prewash step, wherein the additive and/or the liquor is used in the prewash step. The applicants have found that the additive and/or liquor according to the present invention is highly suitable for use in the prewash step. Without wanting to be bound by this theory, the applicants believe that the liquor in a prewash step contains a lower overall level of surfactants, and especially of surfactants that are not intentionally added into the liquor, and that therefore the enzymes in the liquor, in particular the lipase enzyme, experience less competition from surfactants in accessing the soil and stains they are intended to attack and remove. The applicants therefore believe that the performance of the enzymes, and in particular of the lipase enzyme, may be higher in a prewash step as compared to in a main washing step where more surfactant may be present in the liquor, possibly including surfactants that do combine less well with enzymes, in particular with a lipase enzyme.

In an embodiment, the process according to the present invention is further comprising a main washing step, preferably wherein extra surfactant is added to the washing liquor of the main washing step. The washing liquor of the main washing step may possibly but does not necessarily need to be a liquor according to the present invention.

In an embodiment, the process according to the present invention is further comprising a rinsing step, wherein discard water from the rinsing step is used in the preparation of the washing liquor and preferably also in the preparation of the additive. The benefits of this reuse is explained in detail hereinabove.

In an embodiment of the process according to the present invention, the washing or cleaning step is part of an industrial washing process, preferably a laundry washing process. The applicants have found that the present invention is highly suitable for being used on the context of an industrial washing process, in particular a laundry washing process.

In an embodiment of the process according to the present invention, the washing or cleaning step is part of a cleaning-in-place (CIP) process. The applicants have found that the present invention is highly suitable for being used in the context of a CIP process.

In an embodiment of the process according to the present invention as part of a cleaning-in-place process, the washing liquor may be used as a hard surface cleaner.

In an embodiment, the process according to the present invention is using an apparatus for the on-site preparation and application of at least one enzyme-containing additive according to the present invention, the apparatus comprising
at least one mixing vessel for forming a batch of the additive,
at least one feed device connected on the supply side to a plurality of feed sources and on the delivery side to the at least one mixing vessel for feeding the ingredients required for forming the additive,
at least one discharge vessel connected to the at least one mixing vessel for receiving and storing the batch of the at least one additive,
at least one discharging device connected to the at least one discharge vessel for supplying under pressure the additive stored in the at least one discharge vessel,
   whereby at least one of the feed sources is containing at least one enzyme concentrate comprising at least one enzyme that is capable of exhibiting detergent activity,
   whereby the at least one discharge device is equipped with a pump and connected to at least one treatment device suitable for applying the additive by treating at least one object, in particular a textile or food-related object, and for supplying by pumping at least a part of the formed batch of additive to the treatment device,
   wherein the at least one mixing vessel is equipped for forming the batch of the at least one additive having a predetermined amount by weight, and comprising a predetermined amount in weight of the at least one enzyme concentrate.

The applicants have found that the above described apparatus is highly suitable for putting the present invention into practice and for obtaining most of and the maximum of the benefits described herein elsewhere. The applicants submit that the preparation of the enzyme-containing additive with an apparatus as described may be performed in a fully automated manner and without human intervention, which brings a significant advantage in terms of safety and industrial hygiene because the risk for human contact with enzyme-containing liquids, and aerosols therefrom, are strongly reduced.

In a preferred embodiment, the discharging device or devices of the apparatus are in fluid communication with the treatment device or the treatment devices to which the additive should be supplied. The applicants have found that a hardware fluid connection between the apparatus and the treatment device, or for supplying the additive to the at least one treatment device as part of the process according to the present invention, by fixed or flexible piping allowing the transfer of liquids, avoids the need for personnel to handle enzyme-containing products, such as enzyme concentrates or an enzyme-containing additive as a process intermediate, and thus avoids the possible exposure of personnel to such products, including aerosols thereof. The exposure risk may further be minimized by providing an automated washing step of the apparatus or of the equipment used in the process according to the present invention before the equipment is released for a human intervention.

The apparatus also prepares and delivers the additive on a weight basis. The supply of the additive on a weight basis brings the advantage of a highly accurate supply of the amount of enzyme concentrate that is requested and this over a very wide range of dosing amounts. The applicants have found that the apparatus allows the delivery of the requested enzyme concentrates with an accuracy of ±1% and this over a range that includes a dosing as low as 0.02 grams per kilogram of linen but also includes a dosing as high as 1.4 grams per kilogram of linen. The applicants have surprisingly found that the apparatus is thus able to deliver a high dosing accuracy over a dosing range that covers almost two orders of magnitude.

In a preferred embodiment, the apparatus remains the property and under full control of the supplier of the additive, while the treatment devices receiving and consuming the additive are owned and controlled by the provider of the washing or cleaning services, the two forming different parties and usually also being different legal and economic entities.

The enzyme concentrates are commercially available on a weight basis. The applicants have found, because the apparatus produces its batches of additives on a weight basis, and also adds the enzyme concentrates into the batch on a weight basis, that also the additives supplied to the treatment devices may be accounted for on a weight basis, and that the amounts of enzyme concentrates that are delivered to the treatment devices may be accounted for on a weight basis. The provider of the additives may thus charge his supplies to the treatment devices of his customer on a weight basis and therefore in an open and transparent way. Not only is the customer assured of the effectiveness of the supplies of additives from the apparatus and with the process according to the present invention, he may also convincingly be assured that he will only be charged for the enzyme concentrates that actually have been supplied to his treatment devices.

In an embodiment of the present invention, the at least one mixing vessel is equipped for forming the batch of the additive according to a predetermined recipe expressed by weight. The apparatus may for instance be provided with a control device or controller, typically a programmable logic controller or “PLC”. Such a controller may guide the feed devices in supplying amounts from their respective feed sources into the mixing vessel in accordance with a predetermined recipe. This recipe for the preparation may for instance be stored in the memory of the control device. The recipe may for instance be entered manually by means of a keyboard connected by wire or wireless to the control device, possibly assisted by means of a monitor or screen. Alternatively or in addition, such a recipe may be introduced remotely by an electronic connection, wired or wireless, between the control device of the apparatus and a server. This server may possibly be located remotely, e.g. on a site owned by the supplier of the detergent formulation and the connection may be over the internet. The same variety of methods may also be used for adjusting or correcting a recipe that is already stored in an electronic memory as part of the controller or the apparatus, or connected thereto.

In an embodiment of the apparatus as part of the present invention, the at least one mixing vessel is equipped with a weighing cell or balance that is capable of monitoring and signalling the gross weight of the at least one mixing vessel, i.e. including its content. The applicants have found that a suitable mixing vessel and associated weighing cell may be provided such that even small amounts by weight of an ingredient that was actually added into the mixing vessel may be determined with high accuracy. The apparatus may be provided such that it is able to also control the introduction of the ingredients into the mixing vessel with high accuracy, preferably the introduction of the enzyme concentrates. The applicants have found that this arrangement and equipment is highly suitable for achieving a high accuracy in the supply of the amount of additive, and in particular also of the amount of an enzyme concentrate and of the other ingredients that are part of it, and this over a very wide range of dosing amounts, in particular of the enzyme concentrate. The applicants have found that a control unit associated with the apparatus may readily keep track of the amounts by weight of the individual ingredients that are added into the mixing vessel as part of the preparation, and hence is able to derive from that information the recipe according to which the batch of the detergent formulation was actually prepared. This allows for a high accuracy in the preparation of the additive and also for a ready comparison of the actually formed additive formulation and the recipe according to which it was expected to be prepared, and this on a weight basis. It also allows for a highly reliable accountability of each and every ingredient of the additive formulation that is supplied to the treatment device, in particular of any enzyme concentrate that has been used in the preparation of the additive that is supplied to the treatment device. A suitable weighing cell or balance may for instance be selected from the wide range of capacities that are offered under the label Single Point Aluminum Load Cell Model 1022 available from the company Vishay Precision Group (VPG, Malvern, PA 19355, USA).

In an embodiment of the process according to the present invention that is using the above described apparatus, the mixing vessel is provided with a stirring mechanism suitable for homogenizing the additive such that the additive comprises the at least one enzyme concentrate in a predetermined concentration. The stirring mechanism should assure that the amount of enzyme concentrate that is introduced into the mixing vessel is evenly distributed over the batch of additive formulation that is prepared in the mixing vessel. This brings the advantage that every supply of the additive formulation to the treatment device brings along the appropriate amount of the enzyme concentrate, and hence the appropriate amount of the enzyme that is selected and desired for being delivered with the additive to the treatment device.

In an embodiment of the present invention, the apparatus as part of the process according to the present invention is for the on-site preparation and supply of at least two enzyme-containing additive formulations, the apparatus for that purpose comprising at least two discharge vessels each one being connected to its own dedicated discharge device. This brings the advantage that the apparatus is capable of preparing and supplying at least two enzyme containing additive formulations that are different from each other. A first formulation may for instance be designed for washing lightly soiled textiles while a second formulation may be designed for washing heavily soiled textiles. Textiles with intermediate degrees of soiling may then be washed using a mixture of the first and of the second formulation, and the relative ratio of the two formulations in the mixture may each time be adapted for being the perfect match for a wide range of intermediate soiling degrees, or laundry classifications. This versatility may be further enhanced by preparing three different detergent formulations: a first one for lightly soiled textiles, a second one for textiles heavily soiled with one particular type of stains, and a third one for textiles heavily soiled with another particular type of stains. The availability of at least two different enzyme-containing detergent formulations thus strongly enhances the capability of the apparatus to match the supply of enzymes very closely to the type of soiled textiles that need to be washed in one or more treatment devices. This capability strongly enhances one of the most important technical effects, i.e. that the treatment devices supplied by the apparatus are each time supplied with the correct type of enzyme concentrates in a concentration that is correct for the treatment step that it is going to be performing. This capability strongly enhances the advantage that the choice and the dosing of the enzymes become additional and independent parameters in the treatment process downstream of the apparatus. This also brings the advantage that the enzyme concentrates are only used when needed, and in only the concentrations that are needed. This capability thus also enhances the effectiveness and the efficiency of the enzymes used in the treatment process.

In an embodiment of the present invention using the apparatus, the apparatus is comprising a plurality of discharge vessels and wherein the connection between the at least one mixing vessel and the plurality of discharge vessels is equipped with a selecting device capable of establishing a one-on-one relation between the outlet of the at least one mixing vessel and the inlet of one element selected from the plurality of discharge vessels. This brings the advantage that the apparatus may be used to prepare and distribute more than one batch of additives, that these additive formulations may differ from each other. These different additives may be targeting different washing and/or cleaning applications via different discharge vessels. These different additive formulations may also be used in combination with each other, e.g. in different mixture ratios, in order to provide the more appropriate cocktail of ingredients to each one of two or more different applications. This feature thus brings the advantage that the apparatus may serve simultaneously two or more different treatment steps or two or more different treatment devices. The applicants have found that the apparatus is preferably provided with two, more preferably with at least three and even more preferably at least four discharge vessels.

The one-on-one relation brings the advantage of a low risk for cross-contamination between two different batches of additive formulations, e.g. two batches that were prepared by two subsequent preparation cycles of the apparatus.

The applicants have found that in an embodiment a suitable selecting device for establishing the one-on-one relation may be provided by arranging a carousel of a number of discharge vessels below the outlet of the mixing vessel including its associated weighing cell and a valve that is closing off the outlet of the mixing vessel. The mixing vessel outlet may be fixed in a position above the carousel but eccentric to the carousel axis. Each one of the discharge vessels may then be brought underneath the mixing vessel outlet alternatively, e.g. by turning the carousel around a vertical axis until the correct discharge vessel is in position underneath the mixing vessel outlet.

When the preparation of the detergent formulation is completed, when the weight of the mixing vessel content may be registered and when the preparation may have been verified to have happened according to the prescribed recipe, the valve in the mixing vessel outlet may be opened and the mixing vessel content may be emptied into the selected discharge vessel that is located underneath the mixing vessel outlet. Preferably the mixing vessel is located higher than the discharge vessel, and the emptying of the formulation from the mixing vessel into the discharge vessel may occur by draining by gravity. From the difference in weight, as registered by the weighing cell, of the mixing vessel before and after the discharge of the mixing vessel content, the control unit may derive the amount by weight of detergent formulation that was added into the particular discharge vessel that had been positioned underneath the mixing vessel outlet and which may be useful for a correct dosing. The carousel may then turn and bring another discharge vessel underneath the mixing vessel outlet, ready for accepting the next batch of detergent formulation that may be prepared in the mixing vessel subsequently. In this setup it is the carousel which is acting as the selecting device of this embodiment. The discharge vessels may also be open on top to the atmosphere. The opening in the valve that controls the emptying of the mixing vessel may be limited such that the risk for splashing of the mixing level content when this is arriving in the discharge vessel is minimized.

In an embodiment of the present invention, the selecting device is further capable of establishing a one-on-one relation between the outlet of the at least one mixing vessel and the inlet of a waste disposal provision. This provision brings the advantage, if an unacceptable deviation has been observed between the actual preparation procedure and the prescribed recipe, that the mixing vessel content may be rejected as waste and be discarded into the waste disposal provision. The mixing vessel is then again ready for the preparation of a new batch. This provision also brings the advantage that the apparatus may perform a wash step in which the mixing vessel is washed with a solvent or with water in between two successive batch preparations, and the spent solvent or wash water may be kept from entering one of the discharge vessels. In the above embodiment with the carousel, one of the carousel positions that may be brought underneath the outlet of the mixing vessel may be the inlet of the waste disposal provision.

The waste disposal provision may comprise a collection pot into which all drainage of liquids from the various locations in the apparatus may collect, including any splashed or leaked liquids. Such a collection pot may be provided with a high level signal and alarm. Such a level signal may also trigger an activation of a waste disposal pump for pumping the waste liquid from the collection pot into an appropriate waste disposal facility of the site where the apparatus is located.

In an embodiment of the present invention using the apparatus, the at least one discharging device comprises a flow control means. This flow control means may be used for controlling the administration or dosing of the additive formulation to the at least one treatment device. This flow control means may preferably offer the functionality of a controllable flowmeter, and this functionality may for instance be brought by a positive displacement pump of which the flow rate is fixed and the control is offered by controlling the time during which the pump is pumping, as explained further below. This flow control means is preferably instructed, for instance via the apparatus controller, by a dosing system, to deliver a set amount of the additive from the discharge vessel to the treatment device selected from the at least one treatment device to which the discharging vessel is connected.

In an embodiment of the present invention using the apparatus, the pump of the at least one discharging device for pumping the at least one additive from the discharge vessel to the at least one treatment device is positive displacement pump, preferably the pump being a membrane pump. The applicants have found that it is highly convenient to provide a pump as specified as part of the at least one discharging device in the apparatus, in order to perform the supply of the additive to the treatment device. A pump brings the advantage that a flow resistance in the piping connecting the discharge vessel to the at least one treatment device, and its associated pressure drop, may readily be overcome. A further advantage is that the supply of the additive from the discharge vessel may be controlled by controlling the activation of the pump. A positive displacement pump brings the additional advantage that the amount of additive supplied may be controlled by controlling the length of time during which the pump is activated, and that this amount is not affected by pressure changes downstream of the pump.

In an embodiment of the present invention using the apparatus, the supply connection between the at least one discharge device and the at least one treatment device is provided with a back-pressure regulator preferably downstream of the pump that is provided as part of the discharge device. The obstruction formed by the back-pressure regulator brings the advantage that a pressure above atmospheric may be maintained upstream of the back-pressure regulator, and that this pressure remains independent of pressure changes downstream of the back-pressure regulator. The liquid in the discharge vessel is already able to provide a static head above atmospheric pressure. The pump provides an even higher pressure in the supply piping from the discharge vessel towards the at least one treatment device. The pressure above atmospheric brings the advantage that no air from the environment is able to leak into the supply connection. The pressure above atmospheric in the pump outlet also reduces the risk for the pump to cavitate. The applicants have found that the back-pressure controller brings the highly appreciated advantage that the pumping time becomes a highly accurate reflection of the amount of liquid that is supplied during that period of time from the discharge vessel to the at least one treatment device.

In an embodiment of the present invention using the apparatus, the supply connection from the at least one discharge device to the at least one treatment device is provided with a flow sensor, preferably downstream of the pump that is provided as part of the discharge device. The applicants prefer to have an additional sensor which is capable of indicating whether there is at a particular time a flow of liquid through the piping feeding product to a particular treatment device. This sensor is able to confirm or deny whether a particular dose of the additive formulation in the discharge vessel that is being pumped actually is directed to the treatment device for which it is intended. In case of mismatch, the sensor signal or the absence of any signal may be used to set an alarm and/or even to stop the supply that is ongoing but obviously flowing not towards the intended destination.

In an embodiment of the present invention using the apparatus, the at least one discharge vessel is provided with a level sensor for at least detecting a low level in the discharge vessel. This allows the generation of a signal when the inventory of the additive formulation that is stored in that particular discharge vessel is becoming low. Such a signal may be useful for a variety of purposes, such as putting out a warning about the approaching exhaustion of the product stored in that particular discharge vessel. The applicants prefer to set this level sensor at a level at which still a significant amount of inventory is present in the discharge vessel, preferably sufficient inventory for assuring several more dosing amounts, so that the supply from that discharge vessel may continue for longer than the time necessary for the apparatus to prepare a new batch of the same additive formulation and discharging that batch into the discharge vessel for which the level sensor issued the low level signal. The applicants prefer to have the low level sensor at a level at which there is still sufficient inventory in the discharge vessel for continuing the predicted supply during at least 2 hours and in a laundry operation depending on the classifications of the textiles to be treated even up to a full day of further service.

In an embodiment of the present invention using the apparatus, the level signal of the level sensor is equipped for triggering at low level the preparation in the at least one mixing vessel of a new batch of the additive and subsequently the transfer of that new batch into the at least one discharge vessel. This brings the advantage that the preparation of a new batch of the same or a similar formulation may be planned or triggered, such that this particular formulation remains available for the treatment device to which the discharge vessel is connected. The new batch may possibly even be produced following an adjustment of the formulation recipe based for instance on feedback gained about the performance of the previous batch supplied from this additive.

In an embodiment of the present invention using the apparatus, the at least one discharging device is equipped for supplying the additive by, upon demand, transferring to the treatment device (42) from the additive in the discharge vessel during a period of time, preferably a period of time according to the amount of additive that is demanded. Preferably the controller of the apparatus receives as input a request for supplying a particular amount by weight of the particular detergent formulation in a particular discharge vessel towards a particular treatment device. The controller may in response to that request arrange for the one-on-one connection between the discharge vessel and the treatment device and activate the supply activity during a period of time that corresponds to the requested amount, using as the conversion factor a flow rate available in its memory for that supply particular arrangement. In absence of any later calculated flow rate, the controller may use a standard flow rate that was entered into the memory for that supply arrangement when the apparatus was constructed or when the arrangement was installed. If the supply is performed by means of activating a pump associated with the particular discharge vessel, the flow rate for that supply arrangement preferably corresponds to the flow rate of the pump and the standard flow rate may correspond to the nominal flow rate for that pump. If the pump is a positive displacement pump of which the stroke length is fixed, this type of pump brings the advantage of pumping a fixed volume of liquid with each pump cycle. The flow rate of the pump is thus directly proportional to the number of pump cycles performed over a particular time period. If the pump cycle frequency is also fixed, also the flow rate of the pump is fixed. In that case, the amount of detergent formulation transferred by the pump is directly proportional to the length of time during which the pump is activated. The applicants have found that the amount of detergent formulation supplied during a particular period of transfer, and hence the flow rate of the supply connection between the discharge vessel and the at least one treatment device, may readily be available in weight units per time unit. The controller of the apparatus knows the amount by weight of each batch of detergent formulation that has been prepared in the mixing vessel and which has been introduced from the mixing vessel into each discharge vessel. The controller also knows from the level sensor in the discharge vessels the time that it took to supply that same batch of formulation from that discharge vessel, i.e. the sum of all the transfer times during which liquid was drawn from that discharge vessel towards a treatment device in between two consecutive low level signals from the level sensor on that discharge vessel. For achieving high accuracy, the applicants prefer to split the periods of transfer during which the low level signal occurred and assign the time before the moment of the signal, and the associated volume, to the previous batch, while the time after the moment of the signal to the consecutive batch. From this data, the controller is able to derive a flow rate for the supply arrangement feeding from that particular discharge vessel when suppling that particular detergent formulation. The applicants have found that this flow rate may be determined fairly accurately, in particular in case the transfer is performed by a positive displacement pump.

In an embodiment of the present invention, the apparatus is equipped for registering the periods of transferring time of the additive to the treatment device and for reporting the supply of the additive to the treatment device on a weight basis. Most of this mechanism has already been explained above in this document. As explained above, the controller of the apparatus may know fairly accurately the flow rate by weight associated with a particular discharge device. Because it also registers the times during which the discharge device is activated towards a particular and selected treatment device, the controller of the apparatus is able to report the amounts supplied of the additive to the treatment device on a weight basis.

In an embodiment of the present invention, the apparatus is equipped for calculating the times of supply of the additive from the at least one discharge vessel to the at least one treatment device based on the total time of the supplies of at least one previous batch of the additive transferred to the at least one treatment device between two successive low level signals in the at least one discharge vessel and the weight of that at least one previous batch of the additive that was prepared in the at least one mixing vessel. Preferably the actual flow rate for the supply arrangement associated with the discharge vessel may be calculated from the weight of the at least one previous batch of the additive transferred into that discharge vessel and the total time of the supplies of that batch of the additive transferred between two successive low level signals on that discharge vessel. Preferably the applicants prefer to use for the supplies of the subsequent batch the average of the flow rates for the last two batches, more preferably the last three batches, even more preferably the last four batches, and yet more preferably the last five batches. In case there have not yet been the number of desired last batches, the missing flow rates may in the calculation be replaced by the standard flow rate in memory for that particular supply arrangement. The applicants have found that this calculation provides a higher level of accuracy in the subsequent supplies from the discharge vessel to the selected treatment device, hence a higher reliability of the supplies, and therefore a closer approach to the desired optimum performance of the treatment device.

In an embodiment of the present invention, the apparatus is enclosed in an enclosure, preferably an enclosure that may be locked. This brings the advantage that any liquid splashes or any aerosol that may be formed during the operation of the apparatus may be contained inside the enclosure. This brings the advantage that contact of humans with such splashing or aerosol may be avoided. A further advantage, if the enclosure may be locked, is that the apparatus may physically remain under full control of who controls the access to the enclosure, e.g. the supplier of the detergent formulation.

In an embodiment of the present invention wherein the apparatus is enclosed in an enclosure, the enclosure comprises a ventilation system, preferably the exhaust of the ventilation system comprising a filter, preferably a filter capable of also capturing aerosols, more preferably including submicron liquid aerosols. The applicants have found that the ventilation system brings the advantage that the atmosphere inside the enclosure may be cleared from possibly harmful aerosols inside the enclosure as a result of the operations of the apparatus, for instance before the enclosure should be opened for allowing human access, such as for replacing a container of an ingredient, or for maintenance. In order to reduce the impact of the ventilation system of the apparatus and its enclosure on their environment, the applicants prefer to provide a filter on the exhaust system of the enclosure. More preferably the filter is capable of capturing aerosols, such that the risk for the enclosure to emit an aerosol of an enzyme containing liquid is minimized. Preferably the applicants provide a HEPA H14 class filter, according to industry standard EN 1822, according to which such a filter should retain 99.995% of the particles having the most penetrating particle size (“MPPS”).

In an embodiment of the present invention, a drip pan is provided underneath the discharge and mixing vessels. This drip pan is able to collect and contain any liquid drops that may originate from the operations in the apparatus. The drip pan is preferably provided with a bottom that is sloping towards a collection cup, which is provided with a level sensor and a pump for discharging any liquid collected in the collection cup towards a safe discharge facility. Preferably this drip pan is combined with the waste disposal provision and collection pot described above in this document.

In an embodiment of the present invention using the apparatus, the process comprises the steps of:
a. transferring from a plurality of feed sources the ingredients required for forming a batch of the at least one additive into a mixing vessel,
b. mixing the ingredients in the mixing vessel to form the batch of the at least one additive,
c. discharging the batch of the formed additive from the mixing vessel,
d. by pumping supplying at least a part of the batch of the at least one additive to at least one treatment device,
e. the at least one treatment device applying at least a part of the additive for treating at least one object, in particular a textile or food-related object,
wherein the at least one feed source is comprising, and preferably is, an enzyme concentrate of at least one first enzyme that is capable of exhibiting detergent activity, and the preparation is performed on-site with the treatment device.

The process as described makes use of the apparatus located on-site with the treatment devices. This brings a number of significant advantages, in particular in an industrial and/or institutional framework where washing and cleaning operations are of a larger scale and more intense than in a consumer household, and where the priorities and sensitivities are also very different.

An important benefit is an improvement in the safety and industrial hygiene on the site where the treatment device is located, but at the same time also on the location remote therefrom where in the conventional supply chain the additive would be prepared and packaged. The location on-site allows for a hardware fluid connection of the apparatus with the treatment device, by fixed or flexible piping allowing the transfer of liquids, which avoids the need for personnel to handle enzyme-containing products.

A further advantage is that the recipe of the additive that should be delivered to the treatment device may be tailor made and tuned finely to the requirements and desires of the client. The on-site preparation of the additive brings the possibility to adjust the individual dosing of the different enzyme concentrates and this independent of the dosing of any surfactant that may be part of the same additive. The close proximity in time and location between the preparation and the application of the additive allows to use the dosing of each individual one of the available enzyme concentrates as independent parameters in optimizing the cost and the performance of each one of the treatment device. This dosing flexibility is not available in the conventional setting wherein the additive needs to be prepared off-site and transported to the site of consumption.

The close proximity in time and location between the preparation of the formulation and the use thereof, and the dedicated connection between the preparation apparatus and the treatment devices also allows almost immediate feedback on the performance of the formulation, and hence allows a ready adjustment of the formulation to the substances for which the formulation is designed.

Enzymes are introduced into washing and cleaning operations because of their high effectiveness. Only small amounts of the enzyme concentrates are required to deliver the same performance as much higher amounts of surfactants when only surfactants are used. The presence of the correct enzymes in the additive formulation thus allows to significantly reduce the amounts of surfactants that may still be needed in the washing or cleaning operations. The reduction in surfactant need reduces the costs of the detergent formulation, and because the surfactants end up in the waste water where the reduction in surfactant use contributes significantly to the reduction of the BOD and/or COD, and hence to the environmental tax that is levied by the authorities in return for a license to discard that water.

An important feature of the present invention is that the additive is prepared on-site and in batch quantities that may be kept small such that they do not need to be stored long before consumption in the treatment device.

This brings the yet further advantage that the enzyme-containing additive may be prepared with little of any enzyme stabilizing system, preferably even without any. This saves on costs of ingredients, but also on the environmental burden associated with the use of the stabilizer systems, in the first place because of their impact on the BOD and/or COD of the waste water from the site where the treatment device is located.

In an embodiment of the present invention using the apparatus, the apparatus is provided with at least one water supply, and preferably the detergent formulation is water-based, preferably the water supply being a supply of city tap water or of softened city tap water. The additive itself may use water as an ingredient. A further advantage is that the apparatus may be subjected to a wash and/or rinse cycle before any human intervention, to further improve the industrial hygiene on the site of the apparatus.

In an embodiment, the process according to the present invention that is using the above described apparatus comprises that the weight of the mixing vessel (25) including the content thereof is monitored during the transfer of the ingredients into the mixing vessel and the amounts in weight of each added ingredient is controlled and registered. Preferably the transfer of different ingredients is performed sequentially, such that the weight amount of ingredient added during a particular transfer is readily determined as, and preferably also controlled by, the gain in weight registered for the mixing vessel including its content between the first moment just before and the second moment just after the transfer. Preferably the transfer of ingredients into the mixing vessel is performed during periods of time during which none of the other pumps in the apparatus is activated, such as the pumps for the supply from the apparatus to a treatment device or the pump for discarding waste collected from the apparatus. This brings the advantage that the weight measurement of the mixing vessel is not possibly disturbed by any vibration caused by the running of a pump.

This feature also allows the preparation and also the reporting of the amount of the additive, preferably also of the amount of the at least one first enzyme, which is delivered to the at least one treatment device, and this on a weight basis. This brings the advantage of a highly accurate supply of the amount of enzyme concentrate that is requested and this over a very wide range of dosing amounts. The applicants have found that the present invention allows the delivery of the requested enzyme concentrates with an accuracy of ±1% and this over a range that includes a dosing as low as 0.02 grams per kilogram of linen but also includes a dosing as high as 1.4 grams per kilogram of linen. The applicants have surprisingly found that the present invention is thus able to deliver a high dosing accuracy over a dosing range that covers almost two orders of magnitude.

In an embodiment, the process comprises the step of comparing the amounts in weight of all the added ingredients with a predetermined recipe for the detergent formulation. Such a verification enhances the reliability of the apparatus to deliver what is requested, nothing more and nothing less.

In an embodiment, the process comprises, if the prepared batch of the additive formulation was deviating from the predetermined recipe, the step of discharging the batch of the additive towards a waste outlet. In case an unallowable deviation from the recipe is registered, the method may include the step of discarding the mixing vessel content to a waste disposal capability provided to the apparatus. This further enhances the reliability of the supplies from the apparatus to the treatment device.

In an embodiment, the process comprises that the additive is discharged from the mixing vessel into a discharge vessel and the additive is supplied from the at least one discharge vessel to the at least one treatment device. The discharge vessel may be used as a so-called “day tank”, i.e. a temporary inventory of the detergent formulation from which the formulation may be supplied or “dosed” to consuming treatment devices while the mixing vessel is again made available for performing other steps of the method. This brings the advantage that the mixing vessel may be made available for the preparation of another batch of additive while the previous batch is kept in storage and portions thereof may be supplied to a treatment device. This enhances the versatility of the apparatus.

In an embodiment of the process according to the present invention, a plurality of discharge vessels is available for receiving the batch of additives discharged from the mixing vessel and the process comprises, prior to the discharge from the mixing vessel, the step of establishing a one-on-one connection between the outlet of the mixing vessel and the inlet of one element selected from the plurality of discharge vessels and the waste disposal provision, if present. This brings the advantage that the apparatus may be used to prepare and distribute more than one batch of detergent formulations, that these detergent formulations may differ from each other. These different detergent formulations may be targeting different washing and/or cleaning applications via different discharge vessels. These different detergent formulations may also be used in combination with each other, e.g. in different mixture ratios, in order to provide the more appropriate cocktail of ingredients to each one of two or more different applications. Different applications may for instance be different steps as part of the same washing and/or cleaning operation, such as a pre-wash and a main wash, whereby the pre-wash may for instance precede the main wash either in time in the same batch treatment device or in place in the same continuous treatment device. Or the different applications may be similar or different washing and/or cleaning steps performed by two different treatment devices, or by the same treatment device at different times, whereby the objects that are treated may have a different classification. This feature thus brings the advantage that the apparatus according to the present invention may serve simultaneously two or more different treatment steps or two or more different treatment devices. The applicants have found that the apparatus according to the present invention is preferably provided with two, more preferably with at least three and even more preferably at least four discharge vessels.

The one-on-one relation brings the advantage of a low risk for cross-contamination between two different batches of detergent formulations, e.g. two batches that were prepared by two subsequent preparation cycles of the apparatus. This brings the advantage that the risk for cross-contamination between different additive formulations in the transfer from the mixing vessel and the discharge vessel or “day tank” is minimised. The provision of a rinsing step of the mixing vessel, in between the preparation of two consecutive batches having a different composition, may further reduce the risk for cross-contamination, in this case in the mixing vessel itself. Both measures contribute to the assurance that the additive formulation that is supplied is indeed corresponding to what was requested and intended. Other measures, such as the verification of the composition with the recipe, also contribute to this same target.

In an embodiment of the present invention, the apparatus is comprising a selecting device, the selecting device further being capable of establishing a one-on-one relation between the outlet of the at least one mixing vessel and the inlet of a waste disposal provision. The applicants have found that a suitable selecting device for establishing the one-on-one relation may be provided by arranging a carousel of a number of discharge vessels below the outlet of the mixing vessel including its associated weighing cell and a valve that is closing off the outlet of the mixing vessel. The mixing vessel outlet may be fixed in a position above the carousel but eccentric to the carousel axis. Each one of the discharge vessels may then be brought underneath the mixing vessel outlet alternatively, e.g. by turning the carousel around a vertical axis until the correct discharge vessel is in position underneath the mixing vessel outlet. When the preparation of the additive batch is completed, when the weight of the mixing vessel content may be registered and when the preparation may have been verified to have happened according to the prescribed recipe, the valve in the mixing vessel outlet may be opened and the mixing vessel content may be emptied into the selected discharge vessel that is located underneath the mixing vessel outlet. Preferably the mixing vessel is located higher than the discharge vessel, and the emptying of the additive formulation from the mixing vessel into the discharge vessel may occur by draining by gravity. From the difference in weight, as registered by the weighing cell, of the mixing vessel before and after the discharge of the mixing vessel content, the control unit may derive the amount by weight of additive that was added into the particular discharge vessel that had been positioned underneath the mixing vessel outlet and which may be useful for a correct dosing. The carousel may then turn and bring another discharge vessel underneath the mixing vessel outlet, ready for accepting the next batch of additive that may be prepared in the mixing vessel subsequently. In this setup it is the carousel which is acting as the selecting device of this embodiment. The discharge vessels may also be open on top to the atmosphere. The opening in the valve that controls the emptying of the mixing vessel may be limited such that the risk for splashing of the mixing level content when this is arriving in the discharge vessel is minimized.

In an embodiment of the process according to the present invention, the additive is supplied to the at least one treatment device by pumping the additive, preferably by a positive displacement pump, more preferably a membrane pump. The applicants have found that it is highly convenient to provide a pump as part of the at least one discharging device, in order to perform the supply of the additive formulation to the treatment device. A pump brings the advantage that a flow resistance in the piping connecting the discharge vessel to the at least one treatment device, and its associated pressure drop, may readily be overcome. A further advantage is that the supply of the additive from the discharge vessel may be controlled by controlling the activation of the pump. A positive displacement pump brings the additional advantage that the amount of additive supplied may be controlled by controlling the length of time during which the pump is activated, and that this amount is not affected by pressure changes downstream of the pump.

In an embodiment, the process according to the present invention further comprises the step of maintaining a pressure above atmospheric in the supply connection for supplying the additive to the at least one treatment device downstream of the pump. The pressure above atmospheric brings the advantage that no air from the environment is able to leak into the supply connection. The pressure above atmospheric in the pump outlet also reduces the risk for the pump to cavitate. The applicants have further found that the higher pressure brings the highly appreciated advantage that the pumping time becomes a highly accurate reflection of the amount of liquid that is supplied during that period of time from the discharge vessel to the at least one treatment device. The applicants prefer to assure this higher pressure by providing a back-pressure regulator in the fluid connection from the apparatus to the treatment device.

In an embodiment of the process according to the present invention, the supplied amount of the additive is controlled by controlling the time of pumping of the at least part of the additive to the at least one treatment device, using a predetermined pump flow rate in weight for converting the required amount of detergent formulation into a time of pumping needed to supply that amount in weight. Preferably the apparatus is provided with a controller and the controller of the apparatus receives as input a request for supplying a particular amount by weight of the particular additive formulation in a particular discharge vessel towards a particular treatment device. The controller may in response to that request arrange for a one-on-one connection between the discharge vessel and the treatment device and activate the supply activity during a period of time that corresponds to the requested amount, using as the conversion factor a flow rate available in its memory for that supply particular arrangement. In absence of any later calculated flow rate, the controller may use a standard flow rate that was entered into the memory for that supply arrangement when the apparatus was constructed or when the arrangement was installed. If the supply is performed by means of activating a pump associated with the particular discharge vessel, the flow rate for that supply arrangement preferably corresponds to the flow rate of the pump and the standard flow rate may correspond to the nominal flow rate for that pump. If the pump is a positive displacement pump of which the stroke length is fixed, this type of pump brings the advantage of pumping a fixed volume of liquid with each pump cycle. The flow rate of the pump is thus directly proportional to the number of pump cycles performed over a particular time period. If the pump cycle frequency is also fixed, also the flow rate of the pump is fixed. In that case, the amount of additive transferred by the pump is directly proportional to the length of time during which the pump is activated. The applicants have found that the amount of additive supplied during a particular period of transfer, and hence the flow rate of the supply connection between the discharge vessel and the at least one treatment device, may readily be available in weight units per time unit. The controller of the apparatus knows the amount by weight of each batch of additive that has been prepared in the mixing vessel and which has been introduced from the mixing vessel into each discharge vessel. The controller also knows from the level sensor in the discharge vessels the time that it took to supply that same batch of formulation from that discharge vessel, i.e. the sum of all the transfer times during which liquid was drawn from that discharge vessel towards a treatment device in between two consecutive low level signals from the level sensor on that discharge vessel. For achieving high accuracy, the applicants prefer to split the periods of transfer during which the low level signal occurred and assign the time before the moment of the signal, and the associated volume, to the previous batch, while the time after the moment of the signal to the consecutive batch. From this data, the controller is able to derive a flow rate for the supply arrangement feeding from that particular discharge vessel when suppling that particular detergent formulation. The applicants have found that this flow rate may be determined fairly accurately, in particular in case the transfer is performed by a positive displacement pump.

In an embodiment of the process according to the present invention using the predetermined flow rate in weight, the predetermined pump flow rate has been calculated using the total time of pumping that was needed to supply the at least one previous batch of the same additive formulation and the total amount in weight of the corresponding batch registered as part of the preparation of that batch, preferably the calculation using the corresponding total time for pumping of, and the total amount of, the at least two previous batches of the same additive formulation, more preferably the at least three previous batches, even more preferably the at least four previous batches, yet more preferably the at least five previous batches of the same additive formulation. Preferably the applicants prefer to use for the supplies of the subsequent batch the average of the flow rates for the last two batches, more preferably the last three batches, even more preferably the last four batches, and yet more preferably the last five batches. In case there have not yet been the number of desired last batches, the missing flow rates may in the calculation be replaced by the standard flow rate in memory for that particular supply arrangement. The applicants have found that this calculation provides a higher level of accuracy in the subsequent supplies from the discharge vessel to the selected treatment device, hence a higher reliability of the supplies, and therefore a closer approach to the desired optimum performance of the treatment device.

In an embodiment, the process according to the present invention comprises the reporting of the amount in weight of the additive formulation, preferably also of the amount of the at least one enzyme concentrate, that has been delivered during a predetermined period of time to the at least one treatment device. The applicants have found that the method provides all the information required for an accurate report of all the deliveries made to the at least one treatment device, and this in weight units and over a period of time that may comply with the needs of the owner of the apparatus and also with the owner of the at least one treatment device. It allows that the apparatus and the treatment device belong to a different legal entity and it allows for an accurate and reliable reporting of the supply of additive formulation from the first entity to the second. This brings the advantage that the apparatus may be coupled to the accounting systems of the supplier of the additive, and that also a significant part of the accounting associated with the supply of the additive may be automated.

In an embodiment of the process according to the present invention, the process comprises the coupling of the apparatus with a server and the server receiving, analysing and transmitting data generated by the apparatus, including the amounts in weight of the additive delivered to the at least one treatment device, optionally the coupling being made via the internet and/or more preferably using a wireless network. The coupling and the associated exchange of information may for instance make use of the internet. The exchange may also be made possible via a wireless connection between the apparatus and a smartphone, tablet or personal computer of a person associated with the owner of the apparatus. The exchange, i.e. transmitting and/or receiving, of information is particularly advantageous for remote monitoring of the performance of the apparatus and for adjustment where necessary. The exchange may also offer possibilities for the accounting of the services delivered by the apparatus to the treatment devices. An external network preferably comprises an external server which is coupled by means of a wireless connection to the processing unit of the device. Such an exchange of information with an external network also provides the option of determining the remaining quantities of ingredients on the basis of the quantities of ingredients that have been consumed. In an embodiment of the present invention the apparatus is provided with a control panel where the user of the apparatus has the possibility of entering the recipes of the additive formulations to be prepared and supplied. The remaining quantities of ingredients in the feed sources or containers may be calculated on the basis of these data. It is however also possible to provide the apparatus with measuring means which monitor the quantity of remaining ingredients in the feed containers.

In an embodiment the process according to the present invention comprises the receipt by the apparatus of signals from the server. Such signals may for instance be recipe upgrades provided by the server. Such a recipe change may however also be introduced by a control panel connected to the controller of the apparatus. The input capability may thus also be provided for manual input on-site on that control panel which may be equipped with a keyboard or other suitable input device, and/or it may be also allow for wireless input from a smartphone, tablet or personal computer handled by an operator, in which case it may also be made possible to communicate with the apparatus remotely.

In an embodiment of the process according to the present invention, the server comprise an administrator keeping track of the amounts in weights and qualities of additive actually delivered to the at least one treatment device. This brings the advantage that the accounting information is collected and stored remotely, and may be readily available to the owner of the apparatus.

In an embodiment, the process according to the present invention further comprises the calculation of the operating costs of the supplies to the at least one treatment device. This calculation may for instance be performed by the administrator on the server. Also this part of the accounting may be performed remotely and without human intervention on-site of the apparatus.

In an embodiment, the process according to the present invention further comprises the step of issuing an invoice for the supplies to the operator or the at least one treatment device. Also this may be performed remotely and without human intervention on-site with the apparatus. The party consuming the additive formulation may be invoiced for the amounts in weight of the actually supplied additive formulations, or for the amounts in weight of the actually supplied ingredients thereof. In another embodiment the supply of the additive may be made depending on the load of the at least one treatment device. In that case, the setup of the apparatus on the site of the treatment device may comprise a “dosing system” which is informed about the amount of object that is intended for being treated by the at least one treatment device at the start of a particular washing and/or cleaning step or cycle. This amount may be expressed in weight units for a laundry wash but also in surface units for a cleaning in place operation. The dosing system may also contain information about how much of which additive formulation should be dosed per unit of object to be treated. This information about dose per unit object to be treated may be the result of an agreement between supplier and consumer and may be different and set dependent on the classification of the object to be treated.

In an embodiment of the process according to the present invention, the invoice is issued by transferring the invoice to an administrator for the at least one treatment device. This brings the advantage that no human intervention is necessary up to and including the delivery of the invoice from the supplier of the detergent formulation to the consumer thereof.

In an embodiment of the process according to the present invention using the apparatus, at least one second feed source is comprising, and preferably is, a concentrate of at least one second enzyme that is capable of exhibiting detergent activity and that is different from the first enzyme. This brings the advantage that the additive may comprise a cocktail of enzyme concentrates, and that the recipe of this cocktail may be tailored to the particular service intended for the treatment device to which the additive is going to be supplied.

In an embodiment of the process according to the present invention, the additive is transferred to a plurality of treatment devices, more particularly at least two treatment devices, preferably at least three and more preferably at least four treatment devices, the treatment devices optionally being of the same type and optionally being different, optionally at least two treatment devices representing two different parts of the same sequence of successive treatment steps. The applicants have found that one species of the apparatus as described may be suitable to supply several treatment steps and several treatment devices in parallel, whereby the treatment devices must not necessarily be of the same type and kind.

In an embodiment of the process according to the present invention, the at least one treatment device is used in the textile laundry industry, in the life sciences or pharma industry, in the food industry, in the cosmetic industry, in a hospital, and/or in the industry that is supplying to hospitals, preferably the at least one treatment device being part of an industrial washing tunnel. The applicants have found that the present invention is highly suitable for being used and employed in at least one of the industries as specified, because of the advantages the invention brings, which are highly appreciated in those industries.

The present invention is now illustrated by specific and detailed embodiments and with references to the drawings.

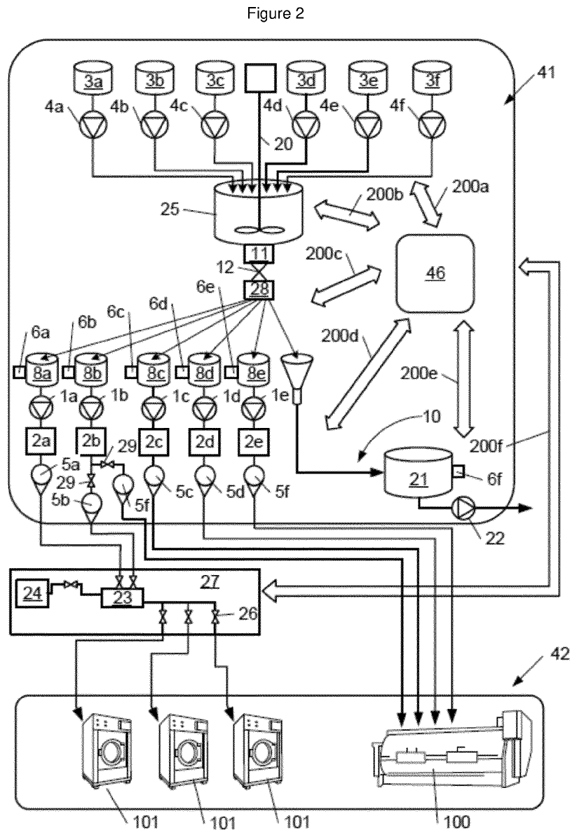

FIG. 2 shows a schematic view of an embodiment of the apparatus 41 according to the present invention and how that apparatus may be connected to a set 42 of treatment devices. The applicants point out that a wide variety of possibilities exists relating to what kind and number of treatment devices may be connected to apparatus 41, and FIG. 2 only shows one of those. In addition thereto, the overall system may even comprise a plurality of similar apparatuses 41 supplying their additive formulations to a set of treatment devices, whereby it may be possible that some treatment devices of the set are only connected to one of the apparatuses, and other treatment devices may be supplied from more than one of the apparatuses.

In the embodiment shown in FIG. 2, the apparatus 41 comprises one mixing vessel 25, positioned on a weighing cell 11 and of which the outlet is controlled by valve 12. Feeding into mixing vessel 25 are six feed devices 4a to 4f which are membrane pumps each one being connected on the supply side to a corresponding feed source or container 3a to 3f. The mixing vessel is equipped with a stirring mechanism 20 comprising a motor and a turbine on an axis that is reaching down into vessel 25.

A additive formulation prepared in the mixing vessel 25 may be drained from the vessel by opening valve 12 and allowing the liquid to flow into one of the destinations selected by the selection device 28 from the five discharge vessels 8a to 8e and waste disposal provision 10. The selection device 28 is provided by mounting all the discharge vessels and the inlet of the waste disposal provision on a carousel which by turning may bring the selected destination underneath the outlet of valve 12. The waste disposal provision further comprises collection pot 21 with level sensor 6f and evacuation pump 22.

Each one of discharge vessels 8a to 8e is provided with a level sensor (6a to 6e), and a membrane pump (1a to 1e) for supplying product from its corresponding discharge vessel to at least one of the treatment devices.

In the set 42 are shown as treatment devices three industrial washing extractors (WE) 101 that work in batch modus a full washing cycle, similar as those performed by a home washing or dishwashing device, and one industrial tunnel washer or continuous bulk washing machine (CBW) 100. Such a tunnel washer 100 operates in semi-continuous mode. The tunnel washer may comprise 15 or more adjacent sections that simultaneously may perform one action during a given period, after which a transport step moves the objects that were subjected to the treatment from one section to the next section. An action performed in one of the tunnel washer steps may be a step selected from the group of a prewash step, a drain step, a heating step, a main wash step, a rinsing step, an extraction step, and less typically also a centrifuging step and a drying action.

Pumps 1a to 1e are each provided with a back pressure regulator 2a to 2e and downstream thereof flow sensors 5a to 5e.

The three discharge vessels 8c to 8e are shown to each have a supply connection directly to one of three entry points in the washing tunnel 100. The two discharge vessels 8a and 8b are shown to each have an indirect supply connection to three washing extractors 101. The two pumps 2a and 2b may push liquid from their respective discharge vessels 8a and 8b into a collector 23 which is also to pull water from a dilution water supply 24. In the collector 23 the supplies from pumps 8a and 8b may be mixed and diluted with water from supply 24, after which the obtained diluted mixture may be sent via manifold 27 and valves 26 to one or more of the washing extractors 101. In addition to its indirect supply to washing extractors 101, pump 1b is also able to supply product to a fourth supply location as part of washing tunnel 100 via flow sensor 5f, provided the two valves 29 in the manifold upstream flow sensor 5f are opened and closed and a one-on-one connection is established between pump 1b and flow sensor 5f directing to tunnel washer 100.

Apparatus 41 further comprises controller 46. Controller 46 is able to perform via connections 200a to 200f the following as needed: activating pumps 4a to 4f, activating the stirring mechanism 20, receiving signals from weighing cell 11, instructing selection device 28, opening valve 12, receiving signals from level sensors 8a to 8e, activating pumps 1a to 1e, receiving signals from flow sensors 5a to 5f, instructing valves 26 and 29, receiving signals from level sensor activating pump 22.

The apparatus 41 is provided inside an enclosure (not shown) that may be locked to prevent unintended access, and which defines a closed environment for the apparatus. The enclosure is provided with a ventilation system for evacuating the content of the closed environment and which comprises a HEPA filter which filters the exhaust of the ventilation system before that is emitted to the surrounding atmosphere.

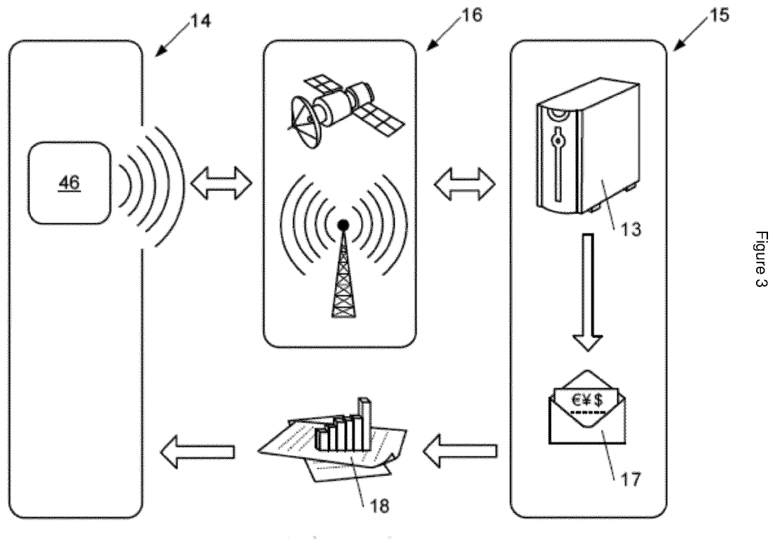

FIG. 3 shows a schematic view of a system for invoicing of an administrator 14 of a treatment device 42 by an administrator 15 of device 41. FIG. 3 shows a system in which some or all information detected by the controller 46 may be transmitted via a wireless network 16 to a server 13 of the administrator 15 of device 41, usually formed by the supplier of the bulk materials. Administrator 15 of device 41 will then be able to calculate the actual operating costs by means of server 13, and on the basis of this information the costs 17 may be charged to an administrator 14 of treatment device 42, who will receive at regular intervals an invoice 18 for the services delivered by apparatus 41 during the latest service period. This is an output-based charging of costs, wherein payment will only be made for the realized consumption. The system as shown in FIG. 2 further comprises the option for the administrator 15 of device 41 of providing the controller 46 of device 41 with diverse information, such as software updates, method improvements and so on, by means of a wireless connection 60.

The system as shown in FIG. 2 comprising device 41 therefore provides the option for administrator 15 of device 41 of monitoring the consumption of starting materials by each individual customer, such as administrator 14 of treatment device 42. The administrator 15 of device 41 hereby has the option of providing the end user proactively with starting materials when the remaining quantity of starting materials falls below a predetermined level.

### EXAMPLES

### Examples 1-3 (E1-E3)—A Complex Enzyme Cocktail as A Versatile Additive According to the Invention

Complex exemplary additives were prepared by mixing the ingredients according to the recipes shown in Table 1. The numbers in the recipes refer to the ingredients as liquid, and hence specify the recipes on a wet basis, using the composition as supplied by the respective suppliers.

TABLE 1

| | Concentration (% wt) | | |
|---|---|---|---|
| Ingredient | E1 | E2 | E3 |
| Lipase concentrate | 49 | 32 | 46 |
| Amine Oxide | 4 | 4 | 4 |
| Protease concentrate | 38 | 43 | 50 |
| Cellulase concentrate | 6 | — | — |
| Amylase concentrate | 3 | 21 | — |

The lipase concentrate was obtained from the company Novozymes A/S (DK) under the tradename Lipex® 100 L. The lipase concentrate was a liquid having a total protein concentration of about 7% wt. The amine oxide was a lauramine oxide obtained from the company Stepan under the tradename Ammonyx® LO. The protease concentrate was a subtilisin concentrate that was obtained from the company Novozymes A/S (DK) under the tradename Coronase® 48 L. The protease concentrate was a liquid having a total protein concentration of about 8% wt. The cellulase concentrate was obtained from the company Novozymes A/S (DK) under the tradename Celluclean® 5000 L. The cellulase concentrate was a liquid having a total protein concentration of about 7% wt. The amylase concentrate was an alpha-amylase concentrate obtained from the company Novozymes A/S (DK) under the tradename Stainzyme® 12.0 L. The amylase concentrate was a liquid having a total protein concentration of about 9% wt.

The additives were analysed by HPLC and the analytical results are given in Table 2.

TABLE 2

| | (% wt) | | |
|---|---|---|---|
| Component | E1 | E2 | E3 |
| Water | 51.210 | 47.84 | 50.84 |
| Total proteins | 7.160 | 7.57 | 7.22 |
| Sorbitol | 15.840 | 10.89 | 15.30 |
| Propylene glycol | 14.600 | 19.75 | 17.30 |
| Glycerol | 7.490 | 9.55 | 5.00 |
| Amine Oxide | 3.200 | 4.00 | 4.00 |
| Phenoxy ethanol | 0.380 | 0.27 | 0.23 |
| Calcium chloride | 0.106 | 0.12 | 0.09 |
| 1,2-Benzisothiazolinone (BIT) | 0.020 | 0.01 | 0.02 |
| Total | 100.006 | 100.00 | 100.00 |

The amount of water is what was already present in the ingredients as supplied. The sorbitol, propylene glycol, glycerol, phenoxy ethanol and calcium chloride also came along as components of the enzyme concentrates, in which they were present as, or as part of, an enzyme stabilizing system. The 1,2-benzisothiazolinone (also called “BIT”) was obtained from the company Thor GmbH (DE) under the tradename MV 14F. This component was added to the composition for its preservative and antimicrobial effects.

The additives were supplied to a variety of washing steps in a variety of textile washing processes, and performed according to the full expectations of the laundry operator. The additives are preferably added in the prewash of a washing process with a washing temperature in the range of 40-60° C., at a working pH between 8-10. These additives may additionally be added in the main wash at the same temperatures. It may be highly suitable for washing hotel linen, restaurant linen, workwear and/or healthcare textiles.

### Example 4—Effect of Surfactants on Lipase Enzyme Activity

The total hydrolysis of rapeseed oil in a wash process was tested with washing liquors that were always comprising the same concentration of a lipase enzyme concentrate. A blank test was performed without any added surfactant. This blank test served as the reference with which could be compared the other results obtained with the same washing liquor samples into which one of a number of different non-ionic surfactants were added.

In the experiments, the lipase concentrate was always present in a concentration of about 0.2 gram of the concentrate per litre of total liquor. The concentrate used was obtained from Novozymes as LIPEX 100 L. The concentrate had a total protein concentration of about 7% wt, as measured using the BCA assay.

The washing liquors always had a pH of about 9.6. The washing tests were performed at a temperature of about 50° C. The water in the formulations was demineralised water obtained by reverse osmosis (RO).

Different washing liquors were prepared containing about 100 ppm by weight of a selected surfactant, to be compared with a blank liquor containing only the lipase enzyme concentrate and no surfactants.

The different surfactants tested were:
A Blank reference containing no intentionally added surfactants
B Linear Alkyl Benzene Sulphonate (LABS or also LAS)
C Lauryl ether sulphate (LES or SLES)
D 3EO-isoC13: isotridecyl alcohol ethoxylated to an average degree of ethoxylation of about 3
E 5EO-isoC13
F 7EO-isoC13
G 9EO-isoC13
H 10EO-isoC13
I C8-C10 alkyl polyglucoside (APG) with an average degree of polymerisation (DP) of 1.5.
J C8-C16 APG-DP of 1.5.
K C8-C10 APG-DP of 1.7
L 3EO-C13-C15: a mixture of linear C13-C15 alcohol that has been ethoxylated to an average degree of about 3
M 5EO-C13-C15
N 7EO-C13-15
O C9-C11 fatty alcohol alkoxylated with an average ethoxylation degree of about 6 and an average propoxylation degree of about 4.
P C12-C14 amine oxide
Q Ammonyx® LO
R Ammonyx® LO

Samples Q and R correspond to the additives according to E2 and E3 respectively.

Further to the lipase concentrate which was present in a concentration of about 0.2 g/l of total liquor, sample Q also contained about 0.27 g/l protease concentrate and about 0.13 g/l amylase concentrate. Further to the lipase concentrate, sample R contained about 0.22 g/l of total liquor of protease concentrate. The concentrations of the surfactant for samples Q and R were increased by spiking extra surfactant in order to reach about 100 ppm.

The above surfactants were obtained as indicated in Table 3.

TABLE 3

| Surfactant | | |
|---|---|---|
| in Sample | Supplier | Under Tradename |
| B | Sasol | Marlon AS3 |
| C | Enaspol (CZ) | Hansanol NS 242 LA |
| D | BASF | Lutensol TO 3 |
| E | Sasol | Marlipal O13/50 |
| F | Sasol | Marlipal O13/70 |
| G | BASF | Lutensol TO 8 |
| H | Sasol | Marlipal O13/100 |
| I | BASF | Glucopon 215 UP |
| J | BASF | Glucopon 650EC |
| K | BASF | Glucopon 225DK |
| L | BASF | Lutensol AO 3 |
| M | BASF | Lutensol AO 5 |
| N | BASF | Lutensol AO 7 |
| O | BASF | Plurafac LF221 |
| P | PCC EXOL (PL) | ROKAnol LP3135 |
| Q | Stepan | Ammonyx LO |
| R | Stepan | Ammonyx LO |

For each liquor was tested the appearance of free oleic acid generated from the hydrolysis of a standard amount of rapeseed oil with which the liquor was brought in contact. Monitored by High Performance Liquid Chromatography (HPLC) was the quantitative release of free oleic acid (C18:1 fatty acid) in the washing liquor and/or present on the textile, as explained as part of the protocols below. Because oleic acid is the main fatty acid in the triglycerides of rapeseed oil, the generation of this acid as free fatty acid it is an excellent quantitative marker for the hydrolysis of rapeseed oil, in this context thus also for the activity of the lipase enzyme.

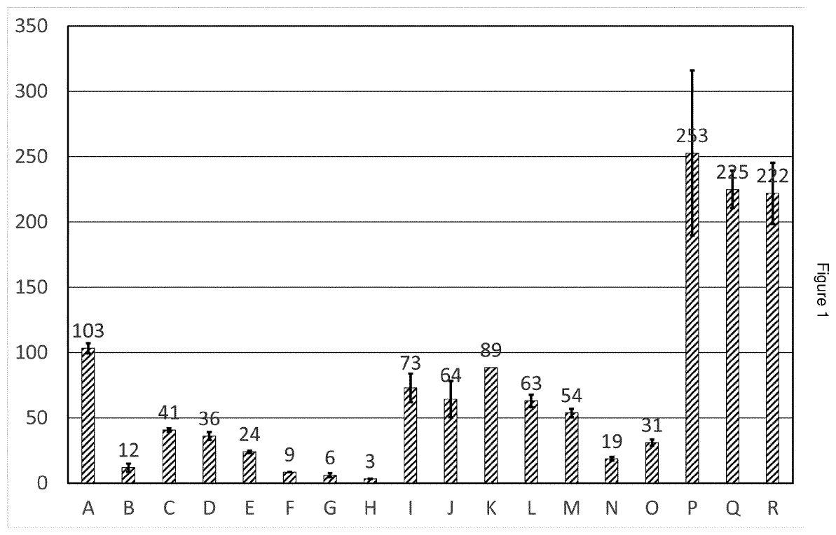

A series of tests were performed using water having a hardness of 2 fH. The results are collected and shown in FIG. 1. The bar chart shows the relative lipase activity of each liquor relative to the activity measured for the blank liquor (A) containing the same enzyme at the same concentration but no surfactants at all, which was set at 100%. For each surfactant choice 2 duplicate samples were tested, except for Sample J (3 duplicates) and Sample K (only 1 sample tested). For the blank, 5 duplicates were tested The bar chart shows the average obtained for the number of duplicates tested as represented by the bar height and the number above the bar. Also shown for each bar with a surfactant is an error bar showing the difference between the lowest and the highest of the duplicates. For the blank, the error bar showed the standard deviation calculated from the results for the five duplicates.

The results in FIG. 1 allow to make a number of important observations. The blank sample, using only the lipase concentrate arrived at producing 103 mg of oleic acid (C18:1) in the washing test.

A first observation is that most surfactants have a reducing effect on the lipase activity in the washing liquor. The most conventional surfactant used in the laundry industry (LABS-Sample B) performs very poorly because it appears to suppress the lipase enzyme activity down to a level of 12% relative to the blank. The suppressing effect of the second conventional surfactant (LES-Sample C) is less: it lands at a reduction of the lipase activity down to about 40% compared to the blank.

The most important observation is the only major exception to the rule of “suppressing lipase enzyme activity”, i.e. that the amine oxide surfactant (P) is able to bring a significant boost to the activity of the lipase enzyme. It is also observed that the presence of other enzyme concentrates, such as protease concentrate (sample R), or protease and amylase concentrates (sample Q) do not significantly affect the boost that is observed due to the presence of the amine oxide surfactant.

Amongst the other surfactants, the alkyl polyglucosides (I, J, K) appear to have a much lower depressing effect as compared to the other surfactants tested. Also relatively benign are some of the ethoxylates of the linear C13-C15 alcohol (L, M), i.e. those having a 3 or 5 average degree of ethoxylation. All these surfactants (I through K) still outperform the conventional surfactants (LABS and LES, samples B and C). The 7EO version of the linear C13-C15 alcohol (sample N) is again having a much larger depressing effect. It appears that the degree of ethoxylation has become too high and the result becomes worse than the LES reference (Sample C). Sample O (the C9-C11 alcohol EO6/PO4-alkoxylate) comes out also worse than the LES reference (Sample C).

All the ethoxylates of iso-C13 alcohol (samples D, E, F, G, H) perform not better than the conventional LES surfactant (Sample C). An increasing degree of ethoxylation appears to enhance the suppressing effect on the lipase activity.

The Test Protocols that were Used

The washing tests consisted of contacting at 50° C. a washing liquor containing the selected surfactant together with 0.2 grams per litre of the lipase enzyme concentrate and having a pH of 9.6 with a polyester swatch type W30-A (PES W30-A textile swatch obtained from the company Center For Testmaterials BV (NL)) that has been pre-treated with an amount of rapeseed oil such that the textile swatch contained about 1.5 grams of rapeseed oil on a total weight of slightly over 8 grams of pre-treated swatch.

In the above examples, the following test protocols were used, which may have been adjusted on the parameters described above as indicated, such as on pH, temperature, contact time and concentration.

The pre-treatment consisting of distributing a generous amount of rapeseed oil over the swatch by means of a paint roller. After applying the rapeseed oil onto the swatch, the impregnated swatch was left to dry for 48 hours between two layers of textile for assuring saturation and for absorbing the excess, after which the swatch was weighed on an analytical balance. The difference with the weight of the swatch before applying the rapeseed oil provides the amount of rapeseed oil that was present on the swatch.

### Washing Test—Fat Removal

### Step 1: Prepare a 1000° Fh Solution

In a first step an aqueous solution of calcium chloride having a predetermined hardness is prepared. A solution having a hardness of 1000 French degrees (1000° fH) is prepared by weighing 11.09 grams of CaCl₂) in a one litre beaker, further filling the beaker to a weight of 1 kg using demineralised water, followed by mixing the beaker content until the calcium chloride is dissolved. The applicants prefer hereby to use demineralised water that has been prepared using reverse osmosis (“RO water”). The hardness of the water produced is preferably also verified, e.g. by using a standard water hardness test kit, to confirm that it is on target.

### Step 2: Prepare the Stock Solution

In a second step a stock solution is prepared for use in the preparation of the samples to be tested. A solution of 0.05 molar (0.05 M) of mono ethanol amine (MEA) in RO water (3.05 grams per kilogram) is heated up to about 45° C., and to this is added an amount of 2 grams per kilogram of the calcium chloride solution of 1000° fH prepared in step 1, to obtain a hardness in the stock solution of 2° fH. Further is prepared an 85% liquid volume (LV %) formic acid solution, and from this is added for pH adjustment until the stock solution reached pH 10.

### Step 3: Washing Test-Part 1

In a 600 ml beaker is introduced 500 grams of the stock solution that was prepared in step 2, and this is brought up to a temperature of 40° C. under stirring by means of a mixer submerged close to the bottom of the beaker at about 200 rpm. To this stock solution is then added 100 microliter (“μl”) of the concentrate of the lipase enzyme. Into this warm solution is then introduced the textile (i.e. the pre-treated PES swatch) to be tested, and the time counting of 10 minutes is started. Where a surfactant should be included, 50 milligram thereof is added into the beaker prior to introducing the lipase enzyme and of the textile.

As preparation for the wash liquor analysis in part 2 of the washing test, an amount of 5 grams of buffer solution having a pH of 4 is introduced into a 250 ml beaker, and 200 μl of the 85% LV formic acid solution prepared above is added. The total weight of the beaker content is noted.

For the analysis of the textile (the swatch after the washing step) an amount of 500 ml of soft water having a hardness of 0.1° fH is introduced in a measuring cup, and to this is also added 200 μl of the same 85% LV formic acid solution as above. The measuring cup content should have a pH of about 4.

### Step 4: Washing Test-Part 2

After the 10 minutes contacting time provided in part 1, about 30 grams of the wash water (or wash liquor) is introduced into the 250 ml beaker containing the buffer solution and the formic acid. The formic acid serves to inactivate the lipase enzyme, so that the reaction is stopped. The total weight of the beaker content is noted and should be ±35 grams.

The textile is removed from the washing test and rinsed by immersion 5 times in the measuring cup prepared in step 3, whereby any lipase enzyme present on the textile becomes also inactivated. The textile is subsequently dried for 10 minutes in a bucket using a household hairdryer with both settings (heating power and fan speed) on medium.

### Step 5: Washing Test-Textile Analysis

The dried textile is first weighed. A piece of 5×5 cm is then cut from the textile and put into a 10 ml vial to which subsequently dimethyl sulfoxide (DMSO) is added up to about 8 grams of total weight in the vial. The weight of the vial content is noted with a precision of 0.001 gram.

The vial is closed with its cap, and a hole is poked into the cap using a pair of tweezers. The vial is put in a vial tray and the extraction of the textile by the DMSO is performed during 10 minutes while the vial tray is placed in a thermostatic bath that is kept at a temperature of 95° C.

After the extraction, the textile is removed from the DMSO solution and, using the pair of tweezers, is put in a syringe having a 25 mm thick filter of a 0.45 μm membrane of polytetrafluorethylene (PTFE). Also the extraction solvent is poured into the syringe. Using the plunger of the syringe, the solvent is pulled through the filter of the syringe, and introduced into a 10 ml glass vial. The amount of oleic acid (C18:1 acid) in this vial is quantified by HPLC, if desired also the surfactants. The amounts are converted into mg of oleic (C18:1) acid that was present on the textile swatch after the washing test.

### Step 6: Washing Test-Wash Liquor Analysis

A C18 LRC cartridge, obtained from the Company Agilent (US) from its solid phase extraction (SPE) cartridge family offered under the tradename Bond Elut, is pre-conditioned for the SPE, i.e. the adsorbent is activated, by pulling, by means of a syringe connected to the adsorbent end of the cartridge, 3 ml of an aqueous acrylonitrile (“ACN”) solution through the packing using the syringe plunger. The aqueous ACN solution is a HPLC grade solution with a ratio (wt %/wt %) of the ACN/H₂O of 40/60.

In as many passes as necessary, the total beaker content from step 4, which is comprising the about 30 ml of wash liquor from the washing test step 3, is introduced into the opposite (i.e. the open) end of the cartridge and, using the syringe, pulled through the packing of the cartridge, whereby all the organics of interest (oleic acid, diglycerides, triglycerides, and surfactants) become adsorbed on the packing. The syringe is removed from the cartridge and its content may be discarded as waste. Subsequently the packing in the C18 LRC cartridge is eluted with 5 ml of HPLC grade methanol (MeOH) using another syringe, whereby a 5 ml solution of all the organics of interest dissolved in the pure methanol is obtained.

The solvent including its dissolved organics is recovered from the syringe into a 10 ml glass vial, from which a 1.5 ml HPLC vial is filled for HPLC analysis. The amount of oleic acid (C18:1 acid) is quantified by HPLC, if desired also the surfactants and other organics of interest. The amount is converted into mg of oleic (C18:1) acid that was present in the washing liquor after the washing test.

### Step 7: Calculating the Results

The amounts of oleic acid present in the washing liquor, from step 6, and on the washed textile swatch, from step 5, are added together to obtain the total amount of oleic acid that was produced during the 10 minute washing test. The results are reported in mg of total oleic (C18:1) acid retrieved after the washing test, and these results are shown as such in the bar chart of FIG. 1.

It may readily be assumed, because of the high excess of triglycerides, that by far most of the oleic acid formed is from the first hydrolysis step in which a triglyceride molecule is hydrolysed into a diglyceride plus one oleic acid molecule. In addition, any oleic acid formed from the further hydrolysis of the diglyceride or subsequently obtained monoglyceride would also be due to the hydrolysing activity of the lipase enzyme. The applicants consider it therefore correct to use the total appearance of oleic acid as a meaningful representation of the activity of the lipase enzyme in the washing test.

### Example 5-Effect of Surfactant Concentration

Extra experiments were performed with 5EO-isoC13 surfactant. These demonstrated that the suppressing activity already becomes noticeable at a surfactant concentration of 10 ppm by weight, that the effect further grows until the concentration of the surfactant reaches about 100 ppm by weight, but remains about the same when further increasing the surfactant presence, and this up to a concentration of 250 ppm by weight. This extra experiment demonstrated that the concentration of 100 ppm by weight of surfactant that was used in the test is expected to allow a meaningful comparison with the blank liquor.

### Example 6-Effect of Water Hardness

The effect of water hardness on the lipase activity was assessed in a series of experiments without any surfactants, with different levels of presence of the lipase enzyme concentrate and using water with different levels of hardness (expressed in French degrees hardness (° fH), as above). A series of tests were performed at lipase concentrate levels in the washing liquor of 0.01 g/litre, 0.20 g/litre and 1.00 g/litre. This series of tests were performed using RO water (0° fH), and repeated using water having a hardness of respectively 2° fH, 7° fH and 20 fH.

The tests using soft water (0° fH) showed hardly any lipase activity at all the tested levels of concentration of the lipase concentrate. Only a small concentration response of the lipase activity became noticeable with the liquor that was made using the 2° fH water. The wash liquor made with 7° fH water showed a surprisingly sharp increase when the lipase concentrate level increased from 0.01 to 0.20 g/litre, and the activity remained the same when the presence of the lipase concentrate was raised to 1.00 g/litre. The wash liquor made using the 20° fH water resulted in activity values very close to these observed at 7° fH. No further beneficial effect could be observed with the higher hardness water, but the results did also not suffer.

### Example 7: Industrial Trial Using the Apparatus of FIG. 2

The apparatus similar to apparatus 41 shown in FIG. 2 was installed on the site of an industrial laundry service provider. Discharge vessel 8b was connected via the set of 2 valves 29 to two tunnel washers CBW1 and CBW2. Discharge vessel 8a was connected via an extra set of valves 29a and associated flow sensors (extra to what is shown in FIG. 2) to the same two tunnel washers CBW1 and CBW2. Although exceptions could occur, CBW1 was primarily dedicated to the washing of light and middle heavily soiled laundry and CBW2 was primarily dedicated to heavily soiled and middle heavily soiled laundry.

Five (5) feed sources were made available as liquid feeds in containers 3a to 3e, according to Table 4:

TABLE 4

| Feed source | Content |
|---|---|
| 3a | Lipase concentrate |
| 3b | Cellulase concentrate |
| 3c | Amylase concentrate |
| 3d | Protease concentrate |
| 3e | Amine Oxide surfactant |

The lipase concentrate was obtained from the company Novozymes A/S (DK) under the tradename Lipex® 100 L. The lipase concentrate was a liquid having a total protein concentration of about 7% wt. The protease concentrate was a subtilisin concentrate that was obtained from the company Novozymes A/S (DK) under the tradename Coronase® 48 L. The protease concentrate was a liquid having a total protein concentration of about 8% wt. The cellulase concentrate was obtained from the company Novozymes A/S (DK) under the tradename Celluclean® 5000 L. The cellulase concentrate was a liquid having a total protein concentration of about 7% wt. The amylase concentrate was an alpha-amylase concentrate obtained from the company Novozymes A/S (DK) under the tradename Stainzyme® 12.0 L. The amylase concentrate was a liquid having a total protein concentration of about 9% wt. The amine oxide was a lauramine oxide obtained from the company Stepan under the tradename Ammonyx® LO.

The apparatus was programmed to prepare from these feed liquids a series of batches of two detergent formulations: Mix A and Mix B, according to the recipes given in Table 5. Only the ingredients listed in Table 4 were used. There was no extra water or solvent added over and above the water and/or other solvent that was introduced as part of those ingredients.

TABLE 5

| Mix | | | | | Amine |
|---|---|---|---|---|---|
| (wt %) | Lipase | Cellulase | Amylase | Protease | Oxide |
| A | X % | Y % | Z % | W % | 4.0% |
| B | 3X % | — | 3Z % | 0.5W % | 4.0% |

The applicants have found, when enzymes are required by the tunnel washers, that a wide variety of laundry classifications may appropriately be washed in a tunnel washer by dosing at least one of the two mixtures Mix A and Mix B, whereby an amount of both may be preferred for the more demanding laundries.

Based on the classification of the different batches of laundries that were supposed to be entered into the tunnel washer, the applicant developed the dosing instructions in grams per kg of treated laundry for dosing Mix A and Mix B into the respective tunnel washers as shown in Table 6. The Blue Workwear classification was not requiring any enzymes of the types available in the apparatus, and was washed without any of the two detergent formulations available in the apparatus.

TABLE 6

| | |
|---|---|
| Tunnel | Dosage in g/kg of linen |

| Washer | Linen Classification | Mix A | Mix B |
|---|---|---|---|
| CBW1 | Sheet | 0.07 | — |
| | Terry Towel | 0.09 | — |
| | Pillow Cases | 0.15 | — |
| | Table Linen | 0.22 | 0.15 |
| | Kitchen Towel | 0.65 | 0.33 |
| CBW2 | White Food Work wear | 0.55 | 0.32 |
| | Nurse Uniform | 0.27 | — |
| | Blue Workwear | — | — |
| | Roller Towel | 0.30 | 0.10 |

For each load of linen entered into each tunnel washer, the dosing system of the respective tunnel washer instructed the apparatus to dose the prescribed amounts of Mix A and/or Mix B into the prewash section of the tunnel washer corresponding to the above dosing instructions and the kg of linen in the load being processed in that prewash section.

At the end of the agreed time period, e.g. each month, the administrator of the apparatus is able to calculate the total amounts consumed of Mix A and Mix B. Using a unit price agreed between supplier and consumer, the supplier of the detergent formulations is able to issue the invoice for this consumer.

The applicants found that the above experiment, performed during one full month at the site of tunnel washers CBW1 and CBW2, was able to maintain desired washing performance while reducing the COD in the waste water from the two tunnel washers by about 25%, thanks for the reduced need for surfactants and the reduced presence of enzyme stabilisers in the two tunnel washers as compared to a month prior to the commissioning of apparatus 41, and this thanks to the appropriate dosing of the most suitable enzyme cocktail and whereby the activity of the lipase enzyme was boosted by the presence of amine oxide as the only surfactant in the detergent formulations.

Having now fully described this invention, it will be appreciated by those skilled in the art that the invention can be performed within a wide range of parameters within what is claimed, without departing from the scope of the invention, as defined by the claims.

1-74. (canceled)

75. An enzyme-containing additive in liquid form for washing or cleaning obtained by bringing together the required ingredients comprising at least one protease enzyme concentrate and at least one lipase enzyme concentrate, wherein
the additive comprises the at least one lipase enzyme concentrate in a concentration of at least 0.2 wt %, taking into account the total enzyme concentrate in its liquid form,
the additive comprises total proteins at a concentration of at least 2.0 wt % of total proteins,
the additive further comprises at least one amine oxide as a surfactant,
characterised in that the additive comprises no intentionally added surfactant other than the at least one amine oxide,
whereby the amine oxide is present in the additive at a concentration of at least 1 wt %, and
whereby the additive contains any unintentionally present surfactants in a total concentration of at most 0.5 wt %.

76. The additive according to claim 75, comprising the at least one protease enzyme concentrate at a concentration of at least 0.2 wt %, taking into account the total enzyme concentrate in its liquid form.

77. The additive according to claim 75, further comprising at least one water hardness increasing compound.

78. An aqueous liquor for washing or cleaning comprising the additive according to claim 75.

79. The liquor according to claim 78, obtained by a process comprising the step of adding water to the additive.

80. The liquor according to claim 79, whereby the water that is added is at least partly water that is discarded from a rinsing step upstream or downstream of a washing step as part of a washing or cleaning cycle.

81. The liquor according to claim 78, wherein the liquor is complying with at least one of the following conditions:
the liquor comprises the at least one lipase enzyme concentrate at a concentration of at least 5 ppm and at most 500 ppm by weight, taking into account the total enzyme concentrate in its liquid form (wet basis),
the liquor comprises the at least one protease enzyme concentrate at a concentration of at least 5 ppm and at most 500 ppm by weight, taking into account the total enzyme concentrate in its liquid form (wet basis),
the liquor comprises total proteins at a concentration of at least 10 ppm by weight and at most 600 ppm by weight,
the liquor further comprises at least one amine oxide as a first surfactant in a concentration of at least 1 ppm by weight and at most 100 ppm by weight,
the liquor optionally further comprises at least one non-ionic surfactant as a second surfactant, preferably an alkoxylated surfactant or an alkyl polyglycoside, more preferably an alkyl polyglycoside, and
the liquor optionally further comprises a total of surfactants other than the at least one amine oxide and the at least one non-ionic surfactant in a concentration of at most 200% of the concentration of the amine oxide, the liquor comprises no surfactant other than the amine oxide,
except for surfactants that are unintentionally present because they may have been present as a component in the non-surfactant ingredients used for preparing the liquor.

82. The liquor according to claim 78, further comprising at least one enzyme concentrate containing at least one enzyme that is selected from the group consisting of mannase, mannanase, pectin lyase, pectolyase, β-glucanase, hemicellulase, catalase.

83. A process for producing the additive according to claim 75, the process comprising the step of adding the at least one lipase enzyme concentrate, the at least one protease concentrate and the at least one amine oxide together, optionally also with a suitable liquid, and mixing the added ingredients and components to form the additive.

84. The process according to claim 83, wherein the additive is prepared on-site with a washing or cleaning step that is using the at least part of the additive.

85. A process for producing the liquor according to claim 78, wherein the liquor is obtained by a process comprising the step of adding to the additive according to claim 75 a liquid that is selected from the group consisting of water and at least one other liquid that is known to stabilize enzymes.

86. The process according to claim 82, for producing and employing the additive, the process using an apparatus for the on-site preparation of at least one enzyme-containing additive, the apparatus comprising
at least one mixing vessel for forming a batch of the additive,
at least one feed device connected on the supply side to a plurality of feed sources and on the delivery side to the at least one mixing vessel for feeding the ingredients required for forming the additive,
at least one discharge vessel connected to the at least one mixing vessel for receiving and storing the batch of the at least one additive,
at least one discharging device connected to the at least one discharge vessel for supplying under pressure the additive stored in the at least one discharge vessel,
whereby at least one of the feed sources is containing at least one enzyme concentrate comprising at least one enzyme that is capable of exhibiting detergent activity,
whereby the at least one discharge device is equipped with a pump and connected to at least one treatment device suitable for applying the additive by treating at least one object, in particular a textile or food-related object, and for supplying by pumping at least a part of the formed batch of additive to the treatment device, wherein the at least one mixing vessel is equipped for forming a batch of the at least one additive having a predetermined amount by weight, and comprising a predetermined amount in weight of the at least one enzyme concentrate.

87. The process according to claim 85, for the on-site preparation and supply of at least two enzyme-containing detergent formulations, the apparatus comprising at least two discharge vessels each one being connected to its own discharge device.

88. The process according to claim 85, comprising the steps of:
a. transferring from a plurality of feed sources the ingredients required for forming a batch of the at least one additive into a mixing vessel,
b. mixing the ingredients in the mixing vessel to form the batch of the at least one additive,
c. discharging the batch of the formed additive from the mixing vessel,
d. by pumping supplying at least a part of the batch of the at least one additive to at least one treatment device,
e. the at least one treatment device applying at least a part of the additive for treating at least one object, in particular a textile or food-related object, wherein the at least one feed source is comprising an enzyme concentrate of at least one first enzyme that is capable of exhibiting detergent activity, and the preparation is performed on-site with the treatment device.

89. The process according to claim 87, wherein the weight of the mixing vessel including the content thereof is monitored during the transfer of the ingredients into the mixing vessel and the amounts in weight of each added ingredient is controlled and registered.

90. A method of employing the additive according to claim 75 as an ingredient in the preparation of an aqueous liquor for a treatment selected from washing and cleaning.
